(19) United States
(12) Patent Application Publication
(10) Pub. No.: US 2023/0137733 A1
(43) Pub. Date: May 4, 2023

(54) MICROWAVE TREATMENT APPARATUS AND METHOD FOR PRODUCING CARBON FIBER

(71) Applicant: Microwave Chemical Co., Ltd., Osaka (JP)

(72) Inventors: Yasunori TSUKAHARA, Osaka (JP); Hisao WATANABE, Osaka (JP); Ryuhei KINJYO, Osaka (JP); Chika KINUGAWA, Osaka (JP)

(73) Assignee: Microwave Chemical Co., Ltd., Osaka (JP)

(21) Appl. No.: 16/962,972

(22) PCT Filed: Dec. 18, 2018
(86) PCT No.: PCT/JP2018/046616

§ 371 Date: Feb. 8, 2021

(30) Foreign Application Priority Data
Jan. 18, 2018 (JP) 2018-006744
Dec. 18, 2018 (JP) 2018-236423

(51) Int. Cl. B01J 19/12; D01F 9/12; H05B 6/78

(52) U.S. Cl. CPC B01J 19/126; D01F 9/12; H05B 6/78; B01J 2219/1281; H05B 2206/04

(57) ABSTRACT

Provided is a microwave treatment apparatus that can properly treat a treatment target using microwaves. The apparatus includes: a vessel 10 in which a treatment target 2 is arranged; a microwave irradiating unit 20 that irradiates an internal portion of the vessel 10 with microwaves; and heat generating member 30 that is provided inside the vessel 10 along the treatment target 2, generates heat by absorbing part of microwaves used for irradiation by the microwave irradiating unit 20, and transmits part of the microwaves. The microwave irradiating unit 20 irradiates a portion in which the heat generating member 30 is provided with microwaves, thereby heating the treatment target 2 from the outside through heat generation at the heat generating member 30, and directly heating the treatment target 2 with microwaves transmitted through the heat generating member 30.

### CROSS REFERENCE TO RELATED APPLICATIONS

This is a U.S. National Phase Application under 35 U.S.C. § 371 of International Patent Application No. PCT/JP2018/046616, filed Dec. 18, 2018, which claims priority of Japanese Patent Application No. 2018-006744, filed Jan. 18, 2018 and Japanese Patent Application No. 2018-236423, filed Dec. 18, 2018. The entire contents of which are hereby incorporated by reference.

### TECHNICAL FIELD

The present invention relates to a microwave treatment apparatus and the like for performing treatment such as heating using microwaves.

### BACKGROUND ART

As a conventional technique for performing treatment using microwaves, an apparatus is known including: a heating furnace body that is made of a microwave shielding material; a microwave part that introduces microwave power to the heating furnace body; a heating tubular member that is made of a heat conductive material having a microwave shielding function, and is provided along a straight line between an inlet port on one side of the heating furnace body and an outlet port on the other side thereof; a microwave heating element that is arranged around the outer circumference of the heating tubular member, and transfers heat to the heating tubular member; and filters that are arranged near the inlet port and the outlet port of the heating furnace body near the ends of the heating tubular member, and prevent leakage of microwave power, wherein a workpiece supplied from the inlet port is caused to pass through the heating tubular member and be discharged from the outlet port, and the workpiece is heated in the heating tubular member (see Japanese Patent No. 5877448, for example).

### SUMMARY OF INVENTION

However, conventional techniques are problematic in that it is not possible to properly treat a treatment target using microwaves.

For example, according to conventional techniques, heating is performed with radiant heat of a microwave heating element heated using microwaves. Thus, a treatment target such as a workpiece can be heated only from the outside, and it is difficult to perform desired heating such as uniform heating.

Furthermore, a treatment target cannot be directly irradiated with microwaves, and thus the treatment target cannot be directly heated by microwaves. Thus, there is a problem in that the heating efficiency is poor.

The present invention was arrived at in order to solve the above-described problems, and it is an object thereof to provide a microwave treatment apparatus and the like capable of properly treating a treatment target using microwaves.

The present invention is directed to a microwave treatment apparatus including: a vessel in which a treatment target is arranged; a microwave irradiating unit that irradiates an internal portion of the vessel with microwaves; and a heat generating member that is provided inside the vessel along the treatment target, generates heat by absorbing part of microwaves used for irradiation by the microwave irradiating unit, and transmits part of the microwaves, wherein the microwave irradiating unit irradiates a portion in which the heat generating member is provided with microwaves, thereby heating the treatment target from an outside through heat generation of the heat generating member, and directly heating the treatment target with microwaves transmitted through the heat generating member.

With this configuration, it is possible to properly treat the treatment target, by combining heating from the heat generating member through microwave irradiation and direct heating of the treatment target.

Furthermore, according to the microwave treatment apparatus of the present invention, the microwave treatment apparatus may be such that the treatment target moves inside the vessel, the heat generating member is provided along part of a movement path of the treatment target, and is not provided in other portions along the movement path, and the microwave irradiating unit performs first microwave irradiation by which the portion in which the heat generating member is provided on the movement path is irradiated with microwaves, thereby heating the heat generating member, and second microwave irradiation by which a portion in which the heat generating member is not provided on the movement path is irradiated with microwaves, thereby heating the treatment target.

With this configuration, it is possible to properly treat the treatment target, by combining heating of the treatment target from the heat generating member, and direct heating of the treatment target in the portion in which the heat generating member is not provided, on the movement path.

Furthermore, according to the microwave treatment apparatus of the present invention, the microwave treatment apparatus may be such that the microwave irradiating unit includes: one or more first irradiating portions that perform the first microwave irradiation; and one or more second irradiating portions that perform the second microwave irradiation.

With this configuration, it is easy to individually control the power of the first microwave irradiation and the power of the second microwave irradiation, and thus it is possible to efficiently perform treatment on the treatment target, and to obtain a treatment result with a high quality.

Furthermore, according to the microwave treatment apparatus of the present invention, the microwave treatment apparatus may be such that the microwave irradiating unit includes two or more irradiating portions that perform irradiation with microwaves from different positions, and phases of microwaves that are used for irradiation by the two or more irradiating portions are controlled, so that the first microwave irradiation in which microwaves used for irradiation by the two or more irradiating portions are intensified by each other at the heat generating member, and the second microwave irradiation in which microwaves used for irradiation by the two or more irradiating portions are intensified by each other at the treatment target are performed.

With this configuration, it is easy to set and change the position at which heating is performed through the first microwave irradiation and the position at which heating is performed through the second microwave irradiation, by controlling the phases.

Furthermore, according to the microwave treatment apparatus of the present invention, the microwave treatment apparatus may be such that the microwave irradiating unit performs: first microwave irradiation by which the heat generating member is irradiated with microwaves with a frequency corresponding to a half-power depth at which microwaves absorbed by the heat generating member are greater than microwaves transmitted through the heat generating member; and second microwave irradiation by which the heat generating member is irradiated with microwaves with a frequency corresponding to a half-power depth at which microwaves absorbed by the heat generating member are less than microwaves transmitted through the heat generating member, so that the treatment target is irradiated with the microwaves transmitted through the heat generating member.

With this configuration, it is possible to properly heat the treatment target, by changing a combination of heating of the treatment target through heating of the heat generating member and direct heating of the treatment target, using microwaves with different frequencies.

Furthermore, according to the microwave treatment apparatus of the present invention, the microwave treatment apparatus may be such that the microwave irradiating unit performs: first microwave irradiation by which the heat generating member is irradiated with microwaves with a frequency at which a relative dielectric loss in the heat generating member is larger than a relative dielectric loss in the treatment target; and second microwave irradiation by which the heat generating member is irradiated with microwaves with a frequency at which a relative dielectric loss in the heat generating member is smaller than a relative dielectric loss in the treatment target, so that the treatment target is irradiated with the microwaves transmitted through the heat generating member.

With this configuration, it is possible to properly heat the treatment target, by changing a combination of heating of the treatment target through heating of the heat generating member and direct heating of the treatment target, using microwaves with different frequencies.

Furthermore, according to the microwave treatment apparatus of the present invention, the microwave treatment apparatus may be such that the treatment target moves inside the vessel, the heat generating member includes a first heat generating member that is provided along part of a movement path of the treatment target, and a second heat generating member that is provided along the movement path of the treatment target, at a portion in which the first heat generating member is not provided, wherein absorption of microwaves by the second heat generating member is less than that by the first heat generating member, and the microwave irradiating unit performs first microwave irradiation by which a portion in which the first heat generating member is provided is irradiated with microwaves, and second microwave irradiation by which a portion in which the second heat generating member is provided is irradiated with microwaves.

With this configuration, it is possible to change a combination of heating by the heat generating member and direct heating of the treatment target by microwaves transmitted through the heat generating member between the first heat generating member and the second heat generating member, and to properly treat the treatment target.

Furthermore, according to the microwave treatment apparatus of the present invention, the microwave treatment apparatus may be such that the microwave irradiating unit includes an irradiating portion that irradiates an internal portion of the vessel with microwaves, the treatment target moves inside the vessel, the heat generating member is provided along a movement path of the treatment target so as to cover the treatment target, at part or the whole of the movement path, and a first microwave irradiation position at which microwaves used for irradiation by the irradiating portion are intensified in the heat generating member, and a second microwave irradiation position at which microwaves used for irradiation by the irradiating portion are intensified in the treatment target are provided along the movement path of the treatment target.

With this configuration, it is possible to properly treat the treatment target, by combining heating from the heat generating member at the first microwave irradiation position and direct heating of the treatment target at the second microwave irradiation position.

Furthermore, according to the microwave treatment apparatus of the present invention, the microwave treatment apparatus may be such that multiple irradiating portions are provided along the movement path of the treatment target, and phases of microwaves that are used for irradiation by the irradiating portions are controlled, so that intensity of microwaves at the irradiation positions is controlled.

With this configuration, it is easy to set and change the irradiation positions, by controlling the phases.

Furthermore, according to the microwave treatment apparatus of the present invention, the microwave treatment apparatus may be such that multiple irradiating portions are provided along the movement path of the treatment target, and frequencies of microwaves that are used for irradiation by the irradiating portions are controlled according to properties (material/thickness) of the treatment target and/or the heat generating member, so that absorptions of microwaves at the irradiation positions are controlled.

With this configuration, it is possible to properly heat the treatment target, by changing a combination of heating of the treatment target through heating of the heat generating member and direct heating of the treatment target, by controlling the frequencies.

Furthermore, according to the microwave treatment apparatus of the present invention, the microwave treatment apparatus may further include: a first sensor that acquires information of temperature of the heat generating member at the first microwave irradiation position; a second sensor that acquires information of temperature of the treatment target at the second microwave irradiation position; and a control unit that performs feedback control on power of microwaves for use in the microwave irradiation, using the information of temperature acquired by the first sensor.

With this configuration, it is possible properly control the heating at the first microwave irradiation position and the heating at the second microwave irradiation position.

Furthermore, according to the microwave treatment apparatus of the present invention, the microwave treatment apparatus may be such that the heat generating member is provided along part of a movement path of the treatment target, and is not provided in other portions along the movement path, the second microwave irradiation position is a position at which microwaves used for irradiation by the irradiating portion are intensified in the treatment target in a portion in which the heat generating member is not provided, and the microwave treatment apparatus is further provided with a third microwave irradiation position at which microwaves used for irradiation by the irradiating portion are intensified in the treatment target in a portion in which the heat generating member is provided.

With this configuration, it is possible to properly treat the treatment target, by combining heating from the heat generating member at the first microwave irradiation position, direct heating of the treatment target at the second microwave irradiation position, and direct heating of the treatment target at the third microwave irradiation position in a portion in which the heat generating member having the first microwave irradiation position is provided.

Furthermore, according to the microwave treatment apparatus of the present invention, the microwave treatment apparatus may be such that one or more first microwave irradiation positions and one or more third microwave irradiation positions are the same position in a direction that is along the movement path.

With this configuration, it is possible to properly treat the treatment target, by combining heating from the heat generating member at the first microwave irradiation position and direct heating of the treatment target at the third microwave irradiation position, at the same position in the direction that is along the movement path.

Furthermore, according to the microwave treatment apparatus of the present invention, the microwave treatment apparatus may be such that two or more heat generating members are provided along the movement path such that an area in which no heat generating member is provided is interposed therebetween, and one or more first microwave irradiation positions and one or more third microwave irradiation positions are provided in portions in which different heat generating members are provided.

With this configuration, it is possible to individually perform heating from the heat generating member at the first microwave irradiation position and direct heating of the treatment target at the third microwave irradiation position, on the treatment target in portions in which different heat generating members are provided, and to properly treat the treatment target.

Furthermore, according to the microwave treatment apparatus of the present invention, the microwave treatment apparatus may be such that phases of microwaves that are used for irradiation by the irradiating portion are controlled such that microwaves are intensified at the first microwave irradiation position and the second microwave irradiation position.

With this configuration, it is easy to set and change the first microwave irradiation position and the second microwave irradiation position.

Furthermore, according to the microwave treatment apparatus of the present invention, the microwave treatment apparatus may be such that the microwave irradiating unit performs the second microwave irradiation using microwaves with a frequency that is different from that in the first microwave irradiation.

With this configuration, it is possible to properly control the heating through the first microwave irradiation and the heating through the second microwave irradiation, using different frequencies.

Furthermore, according to the microwave treatment apparatus of the present invention, the microwave treatment apparatus may be such that the frequency of microwaves for use in the first microwave irradiation is a frequency at which a relative dielectric loss in the heat generating member is larger than a relative dielectric loss in the treatment target.

With this configuration, it is possible to efficiently heat the heat generating member in the first microwave irradiation.

Furthermore, according to the microwave treatment apparatus of the present invention, the microwave treatment apparatus may be such that the microwave irradiating unit further performs third microwave irradiation by which a portion in which the heat generating member is provided is irradiated with microwaves with a frequency at which a relative dielectric loss in the heat generating member is smaller than a relative dielectric loss in the treatment target, thereby heating the treatment target in the portion in which the heat generating member is provided.

With this configuration, it is possible to efficiently heat the treatment target in a portion in which the heat generating member is provided, in the third microwave irradiation.

Furthermore, according to the microwave treatment apparatus of the present invention, the microwave treatment apparatus may be such that one or more positions irradiated with microwaves by the first microwave irradiation and one or more positions irradiated with microwaves by the third microwave irradiation are the same position in a direction that is along the movement path.

With this configuration, it is possible to properly treat the treatment target in the portion in which the heat generating member is provided, through heating from the heat generating member in the first microwave irradiation and direct heating of the treatment target in the third microwave irradiation, at the same position in the direction that is along the movement path.

Furthermore, according to the microwave treatment apparatus of the present invention, the microwave treatment apparatus may be such that two or more heat generating members are provided along the movement path such that an area in which no heat generating member is provided is interposed therebetween, and one or more positions irradiated with microwaves by the first microwave irradiation and one or more positions irradiated with microwaves by the third microwave irradiation are provided in portions in which different heat generating members are provided.

With this configuration, it is possible to individually perform heating from the heat generating member through the first microwave irradiation and direct heating of the treatment target through the third microwave irradiation, on the treatment target in portions in which different heat generating members are provided, and to properly treat the treatment target.

Furthermore, according to the microwave treatment apparatus of the present invention, the microwave treatment apparatus may be such that the heat generating member has a tubular shape, and the microwave treatment apparatus further includes a gas supply unit that supplies predetermined gas into the heat generating member.

With this configuration, it is possible to properly treat the treatment target, by supplying gas into the heat generating member.

Furthermore, according to the microwave treatment apparatus of the present invention, the microwave treatment apparatus may be such that the treatment target moves inside the vessel, and at least a portion on a treatment target side in the heat generating member includes a non-transmitting portion that does not transmit microwaves.

With this configuration, it is possible to provide a portion that prevents the treatment target from being directly irradiated with microwaves, and thus it is possible to increase the width of the microwave irradiation control.

Furthermore, according to the microwave treatment apparatus of the present invention, the microwave treatment apparatus may be such that the heat generating member is a member that assists conveyance of the treatment target inside the vessel, and includes a heating medium that generates heat by absorbing microwaves at a portion that comes into contact with the treatment target.

With this configuration, it is possible to perform heating from the heat generating member, through heat conduction from the heating medium that is in contact with the treatment target, and thus it is possible to improve the thermal efficiency.

Furthermore, according to the microwave treatment apparatus of the present invention, the microwave treatment apparatus may be such that the treatment target is a precursor fiber of a carbon fiber, and the microwave treatment apparatus is for use in flame-resistance treatment on the precursor fiber.

With this configuration, it is possible to obtain a precursor of a carbon fiber with a high quality, which has undergone flame-resistance treatment.

Furthermore, according to the microwave treatment apparatus of the present invention, the microwave treatment apparatus may further include: a first sensor that acquires information of temperature of the heat generating member at a portion in which the first microwave irradiation is performed; a second sensor that acquires information of temperature of the treatment target at a portion in which the second microwave irradiation is performed; and a control unit that performs feedback control on power of microwaves for use in the first microwave irradiation, using the information of temperature acquired by the first sensor, and performs feedback control on power of microwaves for use in the second microwave irradiation, using the information of temperature acquired by the second sensor.

With this configuration, it is possible to properly control the heating of the heat generating member through the first microwave irradiation and the heating of the treatment target through the second microwave irradiation.

The present invention is further directed to a method for producing a carbon fiber, including a step of irradiating an internal portion of a vessel with microwaves, the vessel including, therein, a heat generating member that generates heat by absorbing part of microwaves used for irradiation, and transmits part of the microwaves, thereby heating a precursor fiber of a carbon fiber that is provided along the heat generating member, wherein, in the heating step, a portion in which the heat generating member is provided is irradiated with microwaves, so that the precursor fiber is heated from an outside through heat generation of the heat generating member, and the precursor fiber is directly heated with microwaves transmitted through the heat generating member.

With this configuration, it is possible to properly treat the treatment target, by combining heating from the heat generating member through microwave irradiation and direct heating of the treatment target.

According to the present invention, it is possible to properly treat a treatment target using microwaves.

### BRIEF DESCIPTION OF DRAWINGS

FIG. 1 is a cross-sectional view of a microwave treatment apparatus in Embodiment 1 of the present invention.

FIG. 2 shows a view showing a heat generating member of the microwave treatment apparatus in the embodiment (FIG. 2A), and views showing modified examples thereof (FIGS. 2B to 2D).

FIG. 3 is a cross-sectional view showing a modified example of the microwave treatment apparatus in the embodiment.

FIG. 4 shows cross-sectional views showing a modified example of the microwave treatment apparatus in the embodiment (FIGS. 4A and 4B).

FIG. 5 shows a cross-sectional view of the microwave treatment apparatus in Embodiment 2 of the present invention (FIG. 5A), and schematic cross-sectional views thereof (FIGS. 5B and 5C).

FIG. 6 is a cross-sectional view of the microwave treatment apparatus in Embodiment 3 of the present invention (FIG. 6A), and schematic cross-sectional views thereof (FIGS. 6B to 6D).

FIG. 7 is a schematic cross-sectional view illustrating a modified example of the microwave treatment apparatus in Embodiment 2 of the present invention (FIG. 7A), and schematic views thereof (FIGS. 7B to 7D).

FIG. 8 shows schematic views illustrating a modified example of the microwave treatment apparatus in Embodiment 3 (FIGS. 8A to 8D).

### DESCRIPTION OF EMBODIMENT

Hereinafter, embodiments of a microwave treatment apparatus and the like will be described with reference to the drawings. It should be noted that constituent elements denoted by the same reference numerals in the embodiments perform similar operations, and thus a description thereof may not be repeated.

### Embodiment 1

Hereinafter, a microwave treatment apparatus will be described using, as an example, an apparatus that performs flame-resistance treatment on a precursor fiber that is used to produce a carbon fiber.

First, an example of the production process of a carbon fiber will be described. A precursor fiber made of polyacrylonitrile (PAN) or the like is heated in heated air at 200 to 300° C. for 60 to 120 minutes, so that oxidation of the precursor fiber is performed. This treatment is referred to as flame-resistance treatment. In this treatment, a cyclization reaction of a precursor fiber is caused to occur, so that a flame-resistant fiber is obtained through oxygen binding.

Subsequently, the obtained flame-resistant fiber is heated in a nitrogen atmosphere at 1000 to 1500° C. for several minutes, so that the fiber carbonized, and a carbon fiber can be obtained.

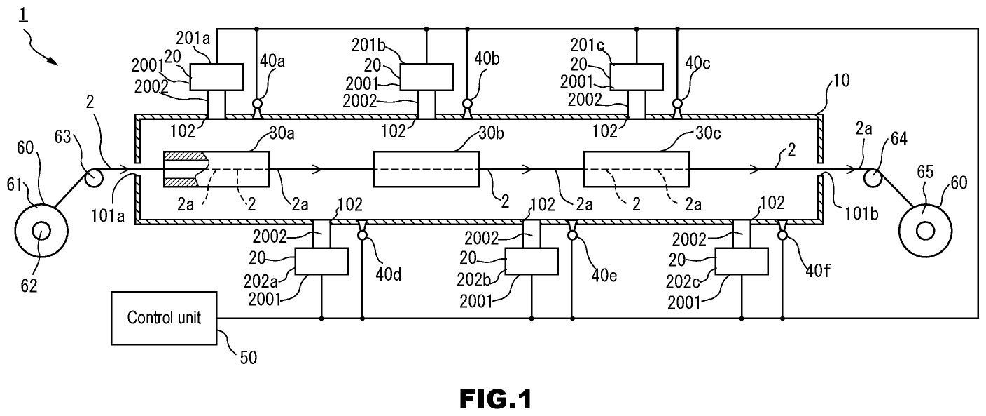

FIG. 1 is a cross-sectional view that is parallel to the movement direction of a treatment target, illustrating a microwave treatment apparatus in this embodiment.

A microwave treatment apparatus 1 includes a vessel 10, a microwave irradiating unit 20, heat generating members 30, one or at least two sensors 40, a control unit 50, and a conveying unit 60.

The vessel 10 is made of a microwave-reflecting material such as stainless steel. The vessel 10 is in the shape of a box that is hollow and horizontally long. The treatment target 2 is arranged inside the vessel 10. In this case, for example, it is assumed that the treatment target 2 is a PAN-based precursor fiber. A precursor fiber that is the treatment target 2 may be, for example, one precursor fiber, or multiple precursor fibers bundled into a string or cord shape. There may be either one or multiple treatment targets 2 that are arranged inside the vessel 10. In the description below, an example in which the treatment target 2 that is arranged inside the vessel 10 moves inside the vessel 10 will be described. This movement may be continuous movement, or non-continuous movement in which movement and stoppage is combined. For example, it is also possible that movement of the treatment target 2 is stopped when microwave irradiation is performed in the vessel 10, and the treatment target 2 is moved when microwave irradiation is not performed. This movement may be movement whose movement speed is constant, or movement whose movement speed continuously or non-continuously changes. The same applies to other embodiments. In the description below, as an example, a case will be described in which the treatment target 2 continuously moves.

One of the two ends in the longitudinal direction of the vessel 10 is provided with an inlet 101a of the treatment target 2, and the other is provided with an outlet 101b. The treatment target 2 enters the vessel 10 from the inlet 101a, moves inside the vessel 10, and exits the vessel 10 to the outside from the outlet 101b. Hereinafter, a case will be described as an example in which the treatment target 2 substantially horizontally moves inside the vessel 10. Note that there is no limitation on the movement direction or the movement paths of treatment targets inside and outside the vessel 10. For example, it is also possible that the movement direction of treatment targets is changed at a point on the path by a roller or the like, or that, for example, the movement direction of precursor fibers is turned once or more by a roller or the like. Typically, the vessel 10 is arranged such that its longitudinal direction is horizontal, but the vessel 10 may be inclined. The inlet 101a and the outlet 101b are provided with filters (not shown) for preventing microwaves with which the internal portion of the vessel 10 is irradiated from leaking to the outside. Examples of the filters include those having a choke structure or the like using the wavelength properties of microwaves, and configured to prevent microwave power from passing therethrough in a non-contact manner. The inlet 101a and the outlet 101b may have a structure for preventing leakage of microwaves, other than filters. There is no limitation on the size of the vessel 10 and the thickness of the outer wall of the vessel 10 and the like. It is also possible that the outer wall of the vessel 10 is provided with a heat insulating material (not shown) or the like. The size of the vessel 10 and the like are determined, for example, according to the treatment target, the treatment time, and the like.

The above-described shape of the vessel 10 is merely an example, and the vessel 10 may have any shape other than that described above. For example, it is also possible that the shape of the vessel 10 is a cylindrical shape that is elongated in the horizontal direction, a polygonal prism shape, or a shape obtained by combining these shapes. It is also possible that the vessel 10 is in a shape that is elongated in the vertical direction. It is also possible that movement path 2a of the treatment target 2 is folded with unshown rollers or the like such that the movement direction of the treatment target 2 is alternately reversed in the horizontal direction, and the vessel 10 is shaped such that at least the portion of the movement path 2a in which the treatment target 2 moves in parallel is covered. In this example, for the sake of ease of description, the treatment target 2 is shown so as to overlap the movement path 2a. On the movement path 2a, the movement direction of the treatment target 2 is indicated by the orientation of the arrows. The same applies to the description below.

The shape, the size, and the like of the vessel 10 are determined, for example, according to the distribution of microwaves with which the internal portion of the vessel 10 is irradiated. For example, the shape and the size of the vessel 10 are preferably set such that the mode of microwaves in the vessel 10 is a multi-mode. The multi-mode of microwaves is, for example, a mode in which there is no stationary waves of microwaves inside the vessel 10.

There is no limitation on the positions at which the inlet 101a and the outlet 101b are provided in the vessel 10. For example, it is also possible that the inlet 101a and the outlet 101b are provided at the same end, side faces, or the like of the vessel 10. The vessel 10 may have multiple inlets 101a and outlets 101b, and, for example, the movement direction of the treatment target 2 may be changed by unshown rollers or the like so that the treatment target 2 enters the vessel 10 via the multiple inlets 101a and exits the vessel 10 via the multiple outlets 101b.

It is preferable that the vessel 10 has a structure that is closed so as to prevent microwaves from leaking, at portions other than those that need to be open, such as the inlet 101a and the outlet 101b of the treatment target 2, later-described opening portions 102, and the like.

Although not shown, the outer periphery of the vessel 10 may be provided with a hot water jacket, a cold water jacket, a heater, or the like for adjusting the temperature of the vessel 1. Also, the vessel 10 may be provided with an unshown observation window through which the internal portion of the vessel 10 can be observed, a ventilating hole and a fan for supplying and exhausting air, and the like.

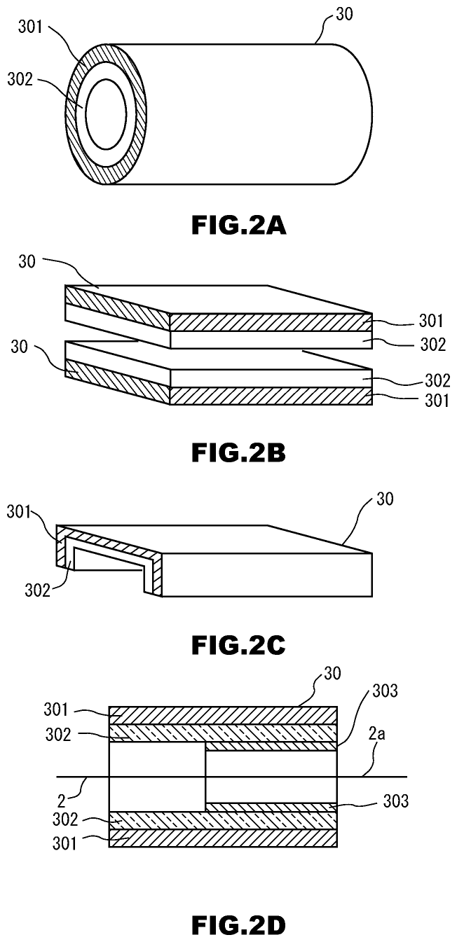

FIG. 2 shows a perspective view schematically showing the heat generating member 30 of the microwave treatment apparatus 1 of this embodiment (FIG. 2A), perspective views schematically showing modified examples of the heat generating member 30 (FIGS. 2B and 2C), and a cross-sectional view taken along the movement path 2a of the treatment target 2, illustrating the modified example of the heat generating member 30 shown in FIG. 2A (FIG. 2D). In the vessel 10, the heat generating members 30 that generate heat by absorbing microwaves used for irradiation by the microwave irradiating unit 20 are provided. It is preferable that, for example, the heat generating members 30 generate heat by absorbing part of microwaves used for irradiation by the microwave irradiating unit 20, and transmit part of the microwaves. The heat generating members 30 are provided along the treatment target 2 that is arranged inside the vessel 10. The state of being provided along the treatment target 2 may be considered, for example, as a state of being provided along the outer periphery of the treatment target 2, or a state of being provided around the treatment target 2. The gap between the heat generating members 30 and the treatment target 2 may be constant or may vary in the longitudinal direction or the movement direction of the treatment target 2, and, in either case, the heat generating members 30 may be considered as being provided along the treatment target. Also, the gap between the portions of each heat generating member 30 that face each other with the treatment target 2 interposed therebetween may be constant or may vary, and, in either case, the heat generating members 30 may be considered as being provided along the treatment target. In this example, the treatment target 2 moves inside the vessel 10, and thus the heat generating members 30 are provided along the movement path 2a of the treatment target 2. For example, the shape of each heat generating member 30 may be any shape, as long as it covers the treatment target 2. The shape of the heat generating member 30 is preferably a cylindrical shape that surrounds the outer periphery of the treatment target 2 as shown in FIG. 2A, but, for example, the shape may be a tubular shape other than a cylindrical shape, such as a ring-like shape or a shape whose cross-section that is perpendicular to the movement direction of the treatment target 2 is in the shape of the letter “U” as shown in FIG. 2C. It is also possible that the heat generating member 30 is constituted by two plate-like members that are arranged such that the treatment target 2 is interposed therebetween as shown in FIG. 2B. Furthermore, the heat generating member 30 may have a tubular shape that partially bulges, a tubular shape that is partially recessed, a tubular shape that is partially curved, or the like.

As shown in FIGS. 2A to 2C, the heat generating member 30 includes a heating medium 301 that generates heat by absorbing microwaves used for irradiation, and a support member 302 that supports the heating medium 301. Typically, the heating medium 301 is arranged on the side face of the support member 302 that does not face the treatment target 2. This side face is, for example, a face that is parallel to the movement direction of the treatment target 2. The heating medium 301 is made of, for example, a heating element such as carbon, SiC, a carbon fiber composite material, a metal silicide (e.g., molybdenum silicide or tungsten silicide), or a ceramic material containing a powder or the like of these heating elements, or the like. The heating medium 301 has, for example, a material and a thickness that allow the heating medium 301 to generate heat by absorbing part of microwaves with which the heat generating member 30 is irradiated, and transmit part of the microwaves used for irradiation. The heating medium 301 has, for example, a material and a thickness that allow the heating medium 301 to transmit part of microwaves with which the heat generating member 30 is irradiated. The heating medium may be a metal layer with a thickness that allows the heating medium to partially transmit microwaves, such as a metal layer with a thickness of several micrometers. The support member 302 is made of a material with high microwave transmission, such as ceramics or glass. The heating medium 301 is formed by, for example, applying or attaching the material of the heating medium 301 to the surface of the support member 302. If the heating medium 301 alone has sufficient strength as in the case in which the heating medium 301 is made of ceramics containing heating elements, the support member 302 may be omitted. The heating medium 301 has, for example, a material and a thickness that allow the heating medium 301 to transmit part of microwaves with which the heat generating member 30 is irradiated. If the support member 302 is used to reinforce the heating medium 301 or to keep the shape of the heating medium 301, the heat generating member 30 may be considered as being constituted only by the heating medium 301. The heat generating member 30 is preferably such that, for example, heat generation by irradiation of the heat generating member 30 with microwaves is greater than heat generation at the treatment target 2 by microwaves transmitted through the heat generating member 30, and the heat generating member 30 preferably has a material and a thickness with which, for example, heat generation by irradiation of the heat generating member 30 with microwaves is greater than heat generation at the treatment target 2 by microwaves transmitted through the heat generating member 30. In this case, the material and the thickness of the heat generating member 30 may be considered as the material and the thickness of the heating medium 301. For example, assuming that a treatment target 2 is one precursor fiber, the heat generating member 30 in the shape of a cylinder has an inner diameter of approximately 9 to 12 mm, or 11 to 14 mm, and the heat generating member 30 has a thickness of approximately 2 to 5 mm. Note that they may have sizes other than these mentioned above.

For example, the heat generating members 30 may be provided at part of the internal portion of the vessel 10 in the longitudinal direction or the movement direction of the treatment target 2, or may be provided throughout the internal portion of the vessel 10 in the longitudinal direction or the movement direction of the treatment target 2. For example, the multiple heat generating members 30 may be provided along the longitudinal direction or the movement direction of the treatment target 2 at desired intervals. In this example, a case will be described in which the heat generating members 30 in the shape of cylinders as shown in FIG. 2A are provided along part of the movement path 2a of the treatment target 2. Specifically, as shown in FIG. 1, three heat generating members 30 in the shape of cylinders are provided at intervals such that the treatment target 2 moves inside the heat generating members 30. In this example, the three heat generating members 30 are denoted by heat generating members 30a to 30c sequentially from the inlet 101a side of the vessel 10. Note that, if they do not have to be distinguished from each other, they are collectively referred to as heat generating members 30. The same applies to other irradiating portions 201, irradiating portions 202, sensors 40, and the like. The lengths in the movement direction of the treatment target 2 of the heat generating members 30 (hereinafter, referred to as lengths of the heat generating members 30), that is, the lengths in the longitudinal direction of the cylindrical shapes may be the same or different from each other, and there is no limitation on the lengths. For example, if the treatment target 2 moves inside the vessel 10, the lengths of the heat generating members 30 may be considered as corresponding to the heating time using the heat generating members 30. The intervals between the heat generating members 30 may or may not be equal intervals, and there is no limitation on the distances thereof. For example, if the treatment target 2 moves inside the vessel 10, the intervals between the heat generating members 30 in the movement direction, the distance between heat generating member 30 that is the closest to the inlet 101a and the inlet 101a, and the distance between the heat generating member 30 that is the closest to the outlet 101b and the outlet 101b (hereinafter, referred to as the length of a portion in which the heat generating member is not provided) may be considered as corresponding to the heating time not using the heat generating members 30. The distance between the heat generating members 30 and the inlet 101a of the vessel 10, and the distance between the heat generating members 30 and the outlet 101b of the vessel 10 may or may not be equal distances, and there is no limitation on the distances thereof. In this example, there is no limitation on the diameters and the like of the heat generating members 30 in the shape of cylinders. The diameters of the heat generating members 30 may be the same or different from each other. In this example, the heat generating members 30 are not in contact with the treatment target 2, but it is also possible that the heat generating members 30 are at least partially in contact with the treatment target. The heat generating members 30 are provided such that their side faces are not in contact with the vessel 10.

In this example, for the sake of ease of description, the case was described in which three heat generating members 30 are provided, but it is sufficient that the number of heat generating members 30 is one or more. For example, if the microwave treatment apparatus 1 is for use in flame-resistance treatment on precursor fibers of carbon fibers that move inside the vessel 10, it is sufficient to set the number of heat generating members to the necessary number of times of heating using the heat generating members 30. In this case, for example, it is sufficient to set the length of each heat generating member 30 to the length corresponding to the period of time necessary for the heating using the heat generating member 30, and to set the length of the portion in which the heat generating member 30 is not provided to the period of time necessary for the heating not using the heat generating member 30. For example, if the movement path 2a of the treatment target 2 is bent, for example, one or more heat generating members 30 may be provided in both of the portion before the bending and the portion after the bending, and, in this case, the heat generating members 30 do not have to be provided on the same straight line.

The microwave irradiating unit 20 irradiates the internal portion of the vessel 10 with microwaves. For example, the microwave irradiating unit 20 is attached to the vessel 10. The microwave irradiating unit 20 performs first microwave irradiation by which the heat generating members 30 are heated, and second microwave irradiation by which the treatment target 2 is heated. The heating the heat generating members 30 may be, for example, heating only the heat generating members 30, or heating the heat generating members 30 at intensity that is higher than that at the treatment target 2. The heating the treatment target 2 may be, for example, heating only the treatment target 2, or heating the treatment target 2 at intensity that is higher than that at the heat generating members 30. Note that the first microwave irradiation is preferably heating that heats the treatment target 2 as well.

The first microwave irradiation is, for example, microwave irradiation in which heat generation at the heat generating members 30 through microwave irradiation is greater than heat generation at the treatment target 2. The first microwave irradiation may be considered as microwave irradiation in which heat generation at the heat generating members 30 is dominant. For example, this heat generation may be considered as the amount of heat generated. This heat generation at the heat generating members 30 may be considered as the amount of heat generated by microwaves and received by the treatment target 2 from the heat generating members 30.

The second microwave irradiation is, for example, microwave irradiation in which heat generation at the treatment target 2 through microwave irradiation is greater than heat generation at the heat generating members 30. The second microwave irradiation may be considered as microwave irradiation in which heat generation at the treatment target 2 is dominant. This heat generation may be considered as the amount of heat generated by microwaves and directly received by or applied to the treatment target 2.

In this embodiment, a case will be described in which the microwave irradiating unit 20 includes one or at least two first irradiating portions 201 that perform first microwave irradiation, and one or at least two second irradiating portions 202 that perform second microwave irradiation.

The first irradiating portions 201 performs first microwave irradiation by which the portions in which the heat generating members 30 are provided on the movement path 2a of the treatment target 2 are irradiated with microwaves, thereby heating the heat generating members 30. That is to say, the first microwave irradiation that is performed by the first irradiating portions 201 is microwave irradiation to the portions in which the heat generating members 30 are provided on the movement path 2a of the treatment target 2. In the first microwave irradiation, heat is preferably generated at the treatment target 2 as well. For example, the first microwave irradiation that is performed by the first irradiating portions 201 is microwave irradiation in which heat generation at the heat generating members 30 due to absorption of part of microwaves that used for irradiation and heat generation at the treatment target 2 due to absorption of part of microwaves that are transmitted through the heat generating members 30 occur, and is microwave irradiation in which heat generation at the heat generating members 30 is greater than heat generation at the treatment target 2.

The first microwave irradiation is microwave irradiation to the heat generating members 30, in which heating of the treatment target 2 from the outside through heat generation at the heat generating members 30 is greater than direct heating of the treatment target due to microwaves transmitted through the heat generating members 30. For example, it is preferable that the material, the thickness, and the like of the heat generating members 30 are set such that the treatment target 2 and the like are heated as described above by microwaves absorbed by the heat generating members 30 and microwaves transmitted through the heat generating members 30.

Furthermore, the second irradiating portions 202 perform second microwave irradiation by which the portions in which the heat generating members 30 are not provided on the movement path 2a of the treatment target 2 are irradiated with microwaves, thereby heating the treatment target 2. That is to say, the second microwave irradiation that is performed by the second irradiating portions 202 is microwave irradiation to the portions in which the heat generating members 30 are not provided on the movement path 2a of the treatment target 2. In the second microwave irradiation that is performed by the second irradiating portions 202, the heat generating members 30 are not provided at the positions that are irradiated with microwaves, and thus the treatment target 2 is not heated from the outside by heat generation at the heat generating members 30 and the like. Accordingly, direct heating of the treatment target 2 through microwave irradiation is greater than heating of the treatment target 2 from the outside by the heat generating members 30 and the like that are irradiated with microwaves.

Hereinafter, in this embodiment, as an example, a case will be described in which the microwave treatment apparatus 1 includes three first irradiating portions 201 and three second irradiating portions 202 as shown in FIG. 1, but there is no limitation on the numbers thereof. In this example, for the sake of ease of description, the three first irradiating portions 201 are denoted by first irradiating portions 201a to 201c sequentially from the inlet 101a side of the vessel 10, and the three second irradiating portions 202 are denoted by second irradiating portions 202a to 202c sequentially from the inlet 101a side of the vessel 10. It is preferable that the power (e.g., wattage, etc.) of microwaves from the one or at least two first irradiating portions 201 and the one or at least two second irradiating portions 202 included in the microwave irradiating unit 20 can be individually changed. For example, the power of the first irradiating portions 201 and the second irradiating portions 202 is controlled according to control signals and the like from a later-described control unit 50. In the microwave treatment apparatus 1 in which multiple heat generating members 30 are provided as shown in FIG. 1, it is preferable that one or more first irradiating portions 201 are provided at positions from which the heat generating members 30 can be directly irradiated with microwaves, and that one or more second irradiating portions 202 are provided, for example, at positions from which at least one or more of the areas between the heat generating members 30, the area between the heat generating member 30 that is the closest to the inlet 101a and the inlet 101a, and the area between the heat generating member 30 that is the closest to the outlet 101b and the outlet 101b can be directly irradiated with microwaves.

Each of the first irradiating portions 201 and the second irradiating portions 202 includes, for example, a microwave oscillator 2001, and a transmitting portion 2002 that transmits microwaves generated by the microwave oscillator 2001, into the vessel 10. The microwave oscillators 2001 may be any type of microwave oscillators 2001, and examples thereof include magnetrons, klystrons, gyrotrons, semiconductor oscillators, and the like. There is no limitation on the frequency, the intensity, and the like of microwaves that are emitted by the microwave oscillators 2001. The frequency of microwaves that are emitted by the microwave oscillators 2001 may be, for example, 915 MHz, 2.45 GHz, 5.8 GHz, or other frequencies ranging from 300 MHz to 300 GHz, and there is no limitation on the frequency thereof. Examples of the transmitting portions 2002 include waveguides, coaxial cables for transmitting microwaves, and the like.

For example, the first irradiating portions 201 and the second irradiating portions 202 are attached to the vessel 10, and irradiate the internal portion of the vessel 10 with microwaves. For example, the first irradiating portions 201 and the second irradiating portions 202 are such that ends of the transmitting portions 2002 to which the microwave oscillators 2001 are not attached are attached to opening portions 102 formed through the wall face of the vessel 10 or the like, and the internal portion of the vessel 10 is irradiated with microwaves emitted by the microwave oscillators 2001 and transmitted through the transmitting portions 2002 through the opening portions 102. The ends of the transmitting portions 2002 attached to the opening portions 102 may be further provided with antennas (not shown) and the like for emitting microwaves transmitted through the transmitting portions 2002. The opening portions 102 may be covered by a material with high microwave transmission such as a fluorinated polymer (e.g., polytetrafluoroethylene: PTFE), glass, rubber, nylon, or the like. The first irradiating portions 201 and the second irradiating portions 202 may be portions other than those described above, as long as the internal portion of the vessel 10 can be irradiated with microwaves.

The first irradiating portions 201 are attached to the vessel 10 such that the portions in which the heat generating members 30 are provided on the movement path 2a of the treatment target 2 in the vessel 10 are irradiated with microwaves. These portions may be considered as areas. For example, the ends of the transmitting portions 2002 of the first irradiating portions 201 are respectively attached to the opening portions 102 formed on the wall face of the vessel 10, at positions that face the portions in which the heat generating members 30 are provided on the movement path 2a. In this example, a case is shown in which one first irradiating portion 201 is provided at one opening portion 102 that is formed at the portion in which one heat generating member 30 is provided, but it is also possible that multiple first irradiating portions 201 are respectively attached to multiple opening portions 102 that are formed at the portion in which one heat generating member 30 is provided.

The second irradiating portions 202 are attached to the vessel 10 such that the portions in which the heat generating members 30 are not provided on the movement path 2a of the treatment target 2 in the vessel 10 are irradiated with microwaves. Specifically, the multiple second irradiating portions 202 are attached such that each of the portions between the heat generating members 30, and the portion between the heat generating member 30 that is on the most downstream side on the movement path 2a and the outlet 101b of the vessel 10 is irradiated with microwaves. For example, the ends of the transmitting portions 2002 of the second irradiating portions 202 are respectively attached to the opening portions 102 formed on the wall face of the vessel 10, at positions that face the portions in which the portions in which the heat generating members 30 are not provided on the movement path 2a. In this example, a case is shown in which one first irradiating portion 201 is provided at one opening portion 102 that is formed at one portion in which no heat generating member 30 is provided, but it is also possible that multiple first irradiating portions 201 are respectively attached to multiple opening portions 102 that are formed at one portion in which no heat generating member 30 is provided.

In this example, it is assumed that microwaves that are used for irradiation by the first irradiating portions 201 and the second irradiating portions 202 are microwaves with the same frequency. Note that it is also possible that one or more of the multiple first irradiating portions 201 and multiple second irradiating portions 202 performs irradiation with microwaves with a frequency that is different from those of the other irradiating portions.

One or more sensors 40 for acquiring information such as the status of treatment target and the status inside the vessel are provided inside the vessel 10. The sensors 40 may be sensors for acquiring any type of status information. For example, they may be temperature sensors for acquiring information of the temperature inside the vessel, humidity sensors s for acquiring information of the humidity inside the vessel, or the like. Alternatively, they may be sensors for detecting discharge inside the vessel due to microwaves, or the like.

In this example, a case will be described as an example in which the sensors 40 are radiation thermometers, and six sensors 40 are provided inside the vessel 10. In this example, for the sake of ease of description, the six sensors 40 are denoted by sensors 40a to 40f sequentially from the inlet 101a side of the vessel 10. A radiation thermometer is a thermometer for measuring the temperature of an object by measuring the intensity of infrared rays or visible rays emitted from the object. In this example, the sensors 40a to 40c that are radiation thermometers are provided near the outlet 101b sides in the areas in which the heat generating members 30 are provided on the movement path 2a, in order to measure the temperature of the treatment target 2 immediately before exiting the areas in which the heat generating members 30 are provided.

Specifically, the sensors 40a to 40c are attached to the vessel 10 such that their positions in the horizontal direction are respectively near the outlet 101b sides in the heat generating members 30a to 30c. Although not shown, it is assumed that, as an example, opening portions such as slits that are elongated in the horizontal direction for detecting the temperature of the treatment target 2 is formed through the heat generating members 30a to 30c, at the portions thereof between the sensors 40a to 40c and the treatment target 2. The sensors 40d to 40f that are the other radiation thermometers are provided near the outlet 101b sides in the areas in which the heat generating members 30 are not provided on the movement path 2a, in order to measure the temperature of the treatment target 2 immediately before exiting the areas in which the heat generating members 30 are not provided. Specifically, the sensors 40d and 40e are attached to the vessel 10 such that their positions in the horizontal direction are respectively on the upstream sides in the heat generating members 30b and 30c in the movement direction of the treatment target 2, and the sensor 40f is attached to the vessel 10 such that its position in the horizontal direction is on the upstream side of the outlet 101b. For example, the sensors 40 acquire information of temperature, by measuring the intensity of infrared rays or the like emitted from the treatment target 2 in the direction that is orthogonal to the movement path 2a. Note that the positions to which the sensors 40 are attached may be other positions. The sensors 40 are attached to, for example, opening portions or the like formed through the wall face of the vessel 10. A precursor fiber is, for example, one fiber with a thickness of approximately 1 mm obtained by twisting several thousands of fibers, and thus, if the treatment target 2 is a precursor fiber, its surface temperature may be regarded as being the same as the temperature inside the precursor fiber.

The control unit 50 controls microwaves that are used for irradiation by the microwave irradiating unit 20. For example, the control unit 50 controls the power of microwaves that are used for irradiation by the microwave irradiating unit 20. For example, the control unit 50 controls the power of microwaves that are used for irradiation by the microwave irradiating unit 20, according to the information acquired by the sensors 40.

In this example, specifically, the control unit 50 performs feedback control on the power of microwaves that are used for irradiation by the first irradiating portions 201 that are configured to irradiate the areas in which the heat generating members 30 are provided on the movement path 2a with microwaves, using the information of temperature acquired by the sensors 40 that are provided on the outlet 101b sides in the areas in which the heat generating members 30 are provided. The control unit 50 performs feedback control on the power of microwaves that are used for irradiation by the second irradiating portions 202 that are configured to irradiate the areas in which the heat generating members 30 are not provided on the movement path 2a with microwaves, using the information of temperature acquired by the sensors 40 that are provided on the outlet 101b sides in the areas in which the heat generating members 30 are not provided. The areas in which the heat generating members 30 are provided and the areas in which the heat generating members 30 are not provided in this case are, for example, areas that are defined by virtual faces that are perpendicular to the movement path 2a. For example, if the temperature acquired by the sensor 40a is higher than a first threshold value, the control unit 50 decreases the power of microwaves that are used for irradiation by the corresponding second irradiating portion 202a, and, if the temperature is lower than a second threshold value, the control unit 50 increases the power of microwaves that are used for irradiation. It is assumed that the first threshold value in this case is a value that is higher than the second threshold value.

The control that is performed by the control unit 50 may be control other than the feedback control. There is no limitation on which irradiating portion is subjected to the control of power by the control unit 50 according to the information acquired by which sensor 40. For example, it is also possible that the control unit 50 controls the power of one or more irradiating portions, according to the output of multiple sensors 40. Also, it is also possible that the control unit 50 controls the power of multiple irradiating portions, according to the output of one sensor 40.

Furthermore, it is also possible that one or more sensors 40 acquire information indicating the status of the heat generating members 30 such as the temperature of one or more heat generating members 30, one heat generating member 30 at different positions, or the like, and the control unit 50 performs control (e.g., feedback control, etc.) on the power of one or more irradiating portions, using the information indicating that status. For example, it is also possible that information of the temperatures of the heat generating members 30 acquired by the sensors 40 configured to acquire information of the temperatures of the heat generating members 30 may be used to perform feedback control on the power of microwaves for use in the first microwave irradiation that is performed to each of the heat generating members 30.

Furthermore, it is also possible that some of the sensors 40 are provided as first sensors that acquire information of temperature of portions in which the first microwave irradiation is performed to the heat generating members 30, some of the sensors 40 are provided as second sensors that acquire information of temperature of portions in which the second microwave irradiation is performed to the treatment target 2, and the control unit 50 performs feedback control on the power of microwaves for use in the first microwave irradiation, using the information of temperature acquired by the first sensor, and further performs feedback control on the power of microwaves for use in the second microwave irradiation, using the information of temperature acquired by the second sensor.

For example, it is also possible that slits or the like are not formed through the heat generating members 30a to 30c, at the portions thereof between the sensors 40a to 40c and the treatment target 2, the sensors 40a to 40c that are the first sensors acquire information of the temperatures of the heat generating members 30a to 30c, and the control unit 50 performs feedback control on the power of microwaves that are respectively used for irradiation by the first irradiating portions 201a to 201c, using the information of the temperatures of the heat generating members 30a to 30c respectively acquired by the sensors 40a to 40c, and further performs feedback control on the power of microwaves that are used for irradiation by the second irradiating portions 202a to 202c, using the information of the temperatures of the treatment target 2 in the areas in which the heat generating members 30 are not provided, respectively acquired by the second sensors 40d to 40f. With this configuration, it is possible to properly control the heating of the heat generating members 30 through the first microwave irradiation and the heating of the treatment target 2 through the second microwave irradiation.

The conveying unit 60 is a unit that conveys the treatment target 2 in the vessel 10. The conveying unit 60 may be provided inside the vessel 10 or provided outside the vessel 10. In this example, as an example, a case is described in which the conveying unit 60 includes a holding portion 62 that rotatably holds a reel 61 around which a precursor fiber that is a treatment target 2 is wound, and a roller 63 that changes the movement direction of the treatment target 2 and sends the treatment target 2 from the inlet 101a into the vessel 10, on the inlet 101a side of the vessel 10, and further includes a roller 64 that changes the movement direction of the treatment target 2 taken out from the outlet 101b of the vessel 10, and a winding portion 65 that takes up the treatment target 2 whose movement direction has been changed by the roller 64. Note that the conveying unit 60 may be any type of conveying units. If multiple treatment target 2 moves inside the vessel 10, multiple conveying units 60 may be provided.

Next, an operation of the microwave treatment apparatus 1 of this embodiment will be described by way of a specific example. In this example, a case will be described as an example in which flame-resistance treatment on a PAN-based precursor fiber that is the treatment target 2 is performed using the microwave treatment apparatus 1. Hereinafter, for the sake of convenience of description, a description will be given using the microwave treatment apparatus 1 shown in FIG. 1. The treatment target 2 are, for example, a precursor fiber having a width of approximately 5 to 10 mm and a thickness of approximately 1 mm to 2 mm. The microwaves that are used for irradiation have, for example, a frequency of 915 MHz or 2.45 GHz and a power of 6 to 20 KW.

First, a PAN-based precursor fiber that is the treatment target 2 is set on the conveying units 60 such that an end thereof enters the vessel 10 from the inlet 101a, moves through each of the heat generating members 30a to 30c in the shape of cylinders, and exits the vessel 10 from the outlet 101b. The conveying units 60 move the treatment target 2 inside the vessel 10. For example, the conveyance speed of the conveying units 60 is controlled to be a predetermined speed. The microwave irradiation by the first irradiating portions 201a to 201c and the second irradiating portions 202a to 202c is started. In this example, it is assumed that the frequencies of microwaves that are used for irradiation by the first irradiating portions 201a to 201c and the second irradiating portions 202a to 202c are the same frequency (e.g., 2.45 GHz). The conveyance speed of the conveying units 60 is controlled to be a predetermined speed, for example, by the control unit 50, an unshown control unit, or the like. The control unit 50 controls the first irradiating portions 201a to 201c and the second irradiating portions 202a to 202c such that the microwaves that are used for irradiation by the first irradiating portions 201a to 201c and the second irradiating portions 202a to 202c are microwaves with powers individually determined in advance.

The portion of the treatment target 2 that enters the vessel 10 from the inlet 101a and moves into the heat generating members 30 is heated from the outside by radiant heat from the heat generating members 30 that are configured to generate heat by absorbing part of microwaves used for irradiation by the first irradiating portions 201, and is directly heated by microwaves that have not been absorbed by the heat generating members 30 and have been transmitted therethrough, out of the microwaves used for irradiation by the first irradiating portions 201. In this case, for example, assuming that the material and the thickness are set such that the amount of heat generated the heat generating members 30a to 30c absorbing microwaves used for irradiation by the first irradiating portions 201a to 201c is sufficiently larger than the amount of heat generated at the treatment target 2 due to microwaves transmitted through the heat generating members 30, heating of the treatment target 2 in the areas inside the heat generating members 30 is such that heating from the outside by the heat generating members 30 is greater than direct heating with microwaves transmitted through the heat generating members 30. The power of microwaves used for irradiation by the first irradiating portions 201a to 201c is subjected to feedback control according to the temperatures of the treatment target 2 respectively acquired by the sensors 40a to 40c, and is controlled such that the treatment target 2 has a temperature in a desired range.

When the portion of the treatment target 2 that entered a heat generating member 30 exits to the outside, the portion enters the area in which no heat generating member 30 is provided, the area being provided immediately after the heat generating member 30, receives microwave irradiation by a second irradiating portion 202 with no heat generating member 30 interposed therebetween, and generates heat due to the microwaves. That is to say, the portion is directly heated by microwaves. In the areas in which the heat generating members 30 are not provided, heating of the treatment target through heat generation at the heat generating members 30, and thus at direct heating with microwaves is greater than heating from the outside by the heat generating members 30 and the like. The power of microwaves used for irradiation by the second irradiating portions 202a to 202c is subjected to feedback control according to the temperatures of the treatment target 2 respectively acquired by the sensors 40d to 40f, and is controlled such that the treatment target 2 has a temperature in a desired range.

In this manner, the first irradiating portions 201 and the second irradiating portions 202 can perform, in a switchable manner as appropriate, the heating in which heat from the heat generating members 30 is dominant and the heating in which direct heat from microwave irradiation is dominant, to the treatment target 2 that moves inside the vessel 10. Accordingly, for example, the heating of the treatment target 2 from the outside and direct heating of the treatment target 2 can be performed in a switchable manner as appropriate, and thus it is possible to uniform heat the treatment target 2 such that the heating is not biased either to the heating from the outside or the direct heating.

In particular, PAN-based precursor fibers not subjected to flame-resistance treatment are unlikely to absorb microwaves, and thus, even when the first irradiating portions 201 heat the heat generating members 30 through microwave irradiation, the treatment target 2 is directly heated by microwaves transmitted through the heat generating members 30. Accordingly, it is possible to reduce the time of the second irradiating portions 202 to heat the treatment target 2.

Furthermore, when the temperature of the treatment target 2 reaches a certain temperature through heating, heat generation at the treatment target 2 may reach its peak, and heat may be abruptly generated at the treatment target 2, which makes it impossible to perform desired treatment due to the treatment target 2 being carbonized, for example. For example, when the temperature of a precursor fiber that is the treatment target 2 reaches a certain temperature through heating, heat generation at the precursor fibers may reach its peak through oxidation, and the precursor fibers may be carbonized. In particular, when the treatment target 2 is heated at high intensity through direct heating in the second microwave irradiation, since the thermal efficiency and the portions at which heat is generated are concentrated at one point, for example, heating shortly progresses from a temperature immediately before the heat generation peak to a temperature corresponding to the heat generation peak. Accordingly, it is difficult to control the heating around the temperature corresponding to the heat generation peak. Thus, in the case in which the treatment target are heated by performing the second microwave irradiation, if the heat generating members 30 are provided such that, when the temperature of the treatment target 2 is about to reach the temperature corresponding to the heat generation peak, the microwave irradiation is switched from the second microwave irradiation to the first microwave irradiation, the heating of the treatment target 2 is switched to heating with radiant heat from the heat generating members 30, and thus carbonization and the like can be suppressed by suppressing abrupt heating.

For example, if the treatment target 2 is moved and heated inside the vessel 10 as in the microwave treatment apparatus 1 as shown in FIG. 1, it is possible to know in advance which position the treatment target 2 has reached when the heat generation reaches its peak, based on the movement speed, and the number, the arrangement, the power, and the like of the first irradiating portions 201 and the second irradiating portions 202. It is also possible that this position is detected through an experiment or the like. Thus, for example, if the heat generating members 30 are provided on the movement path 2a of the treatment target 2, at the position at which the temperature of the treatment target 2 reaches its peak in the heat generation, and the positions before and after that position, and the heat generating members 30 is irradiated with microwaves from the first irradiating portions 201, it is possible to avoid abrupt heating when heat generation at the treatment target 2 reaches its peak, and to properly treat the treatment target 2. Furthermore, if the heat generating members 30 are provided or not provided as appropriate at positions not including the position at which the heat generation reaches its peak, the microwave irradiation to the treatment target 2 that moves is switched between the first microwave irradiation and the second microwave irradiation, it is possible to perform uniform heating and desired heating of the treatment target 2. Note that the temperature corresponding to the heat generation peak of a treatment target can be measured, for example, through TG-TDA measurement (thermogravimetry-differential thermal analysis measurement) or the like.

The number of heat generating members 30, the number and the arrangement of the first irradiating portions 201 and the second irradiating portions 202, and the like in this specific example are merely an example, and there is no limitation on the number of heat generating members 30, the number and the arrangement of the first irradiating portions 201 and the second irradiating portions 202, and the like.

As described above, in this embodiment, it is possible to properly treat a treatment target using microwaves, by performing the first microwave irradiation by which a heat generating member is heated and the second microwave irradiation by which a treatment target is heated, in a vessel. For example, it is possible to perform proper heating, by controlling the combination and the ratio between the heating of a treatment target from the outside by a heat generating member caused to generate heat by microwaves, and the direct heating by causing a treatment target to generate heat with microwaves.

Furthermore, if the first microwave irradiation is performed at the first irradiating portions 201 and the second microwave irradiation is performed at the second irradiating portions 202, it is possible to individually control the power of the first microwave irradiation and the power of the second microwave irradiation, to control the heating of treatment targets in detail, and to obtain a treatment result with a high quality.

As shown in FIG. 2D, it is also possible that a non-transmitting portion 303 that does not transmit microwaves are provided on at least a portion on the treatment target 2 side in the heat generating members 30. FIG. 2D is a cross-sectional view along the movement direction of the treatment target 2, illustrating an example of a heat generating member 30 in which the non-transmitting portion 303 is provided inside the heat generating member 30 in the shape of a tube shown in FIG. 2A. It is preferable that at least a portion on the treatment target 2 side in the heat generating member 30 is a portion on the treatment target 2 side in the heat generating member 30, but it may be the entirety on the treatment target 2 side in the heat generating member 30. For example, at least a portion of the heat generating member 30 on the treatment target 2 side is part of the internal portion of the heat generating member 30 in the shape of a cylinder as shown in FIG. 2D. If multiple heat generating members 30 are provided inside the vessel 10, the portion of the heat generating member 30 on the treatment target 2 side in this case may be the entire face of one or more of the multiple heat generating members 30. It is preferable that the non-transmitting portion 303 is made of a material that does not transmit microwaves and that has a good heat conductivity. Examples of the material of the non-transmitting portion 303 include graphite and metal. It is also possible that the non-transmitting portion 303 is used instead of part of the support member 302, and this configuration also may be considered as a configuration in which a portion on the treatment target 2 side in the heat generating member 30 includes the non-transmitting portion 303. If such a non-transmitting portion 303 is provided, in the portion in which the non-transmitting portion 303 is provided, it is possible to prevent direct heating of the treatment target 2 by preventing the treatment target 2 from being irradiated with microwaves, and to heat the treatment target 2 from the outside through heat generation at the heat generating member 30. The configuration in which at least a portion in the heat generating member 30 may be provided with a non-transmitting portion applies to other embodiments.

In the description above, the thickness of the heat generating member 30 may or may not be a uniform thickness. The state in which the thickness of the heat generating member 30 is not a uniform thickness is a concept that encompasses a state in which there is also a portion with a different thickness. The thickness of the heat generating member 30 may be considered as the thickness of the heating medium 301 of the heat generating member 30. For example, the thickness of the heat generating member 30 may or may not be a uniform thickness in the longitudinal direction of the heat generating member 30 or the movement direction of the treatment target 2. For example, if multiple heat generating members 30 are provided inside the vessel 10, the thickness of one or more of the multiple heat generating members 30 (not all of the heat generating members 30) may be a thickness that is different from those of the other heat generating members 30. In this case, the thickness of each of the multiple heat generating members 30 may be a uniform thickness in the longitudinal direction or the movement direction of the treatment target 2. The same applies to the description below.

For example, in a microwave treatment apparatus as shown in FIG. 1 as described above, instead of the configuration in which the microwave irradiation that is performed to the movement path 2a of the treatment target 2 in the portions in which the heat generating members 30 are not provided is taken as the second microwave irradiation, it is also possible to apply a configuration in which a second heat generating member (not shown) that is thinner than the heat generating members 30 is provided in one or more portions in which the heat generating members 30 are not provided, and the microwave irradiation that is performed from the second irradiating portions 202 to the second heat generating member is taken as the second microwave irradiation. Since the penetration depth of microwaves that are used for irradiation is changed by reducing the thickness of the second heat generating member, if the thickness of the second heat generating member is adjusted, absorption, by the second heat generating member, of microwaves with which the second heat generating member is irradiated can be reduced, the amount of microwaves that are transmitted through the second heat generating member can be increased, and thus the treatment target 2 can be heated at intensity that is higher than that at the second heat generating member. In this case, the treatment target 2 can be heated from the outside as well through heat generation at the second heat generating member.

It is also possible that the thickness of one or more of the multiple heat generating members 30 is different from that of the other heat generating members 30. Accordingly, microwaves that are absorbed by the heat generating members 30 can be changed according to the thickness of the heat generating members 30, and thus the heating of the heat generating members 30 through the first microwave irradiation, and the ratio of the heating of the heat generating members 30 can be changed. The same applies to the second microwave irradiation using the second heat generating members 30. The same applies to the description below.

Furthermore, in the description above, the material of each heat generating member 30 may be the same material or different materials in the longitudinal direction of the heat generating member 30 or the movement direction of the treatment target 2. The different materials may be materials with different compositions, components, material proportions, or the like. The state in which the heat generating member 30 is made of different materials is a concept that encompasses a state in which there is also a portion with a different material. The material of the heat generating member 30 in this case may be considered as the material of the heating medium 301 of the heat generating member 30. For example, if multiple heat generating members 30 are provided inside the vessel 10, the material of one or more of the multiple heat generating members 30 (not all of the heat generating members 30) may be a material that is different from those of the other heat generating members 30. Three or more heat generating members 30 may be constituted by heat generating members 30 made of three or more different materials. In this case, each material of the multiple heat generating members 30 may be a uniform material. The same applies to the description below.

For example, in a microwave treatment apparatus as shown in FIG. 1 as described above, instead of the configuration in which the microwave irradiation that is performed to the movement path 2a of the treatment target 2 in the portions in which the heat generating members 30 are not provided is taken as the second microwave irradiation, it is also possible to apply a configuration in which a second heat generating member (not shown) that is made of a material different from that of the heat generating members 30 is provided in one or more portions in which the heat generating members 30 are not provided, and the microwave irradiation that is performed from the second irradiating portions 202 to the second heat generating member is taken as the second microwave irradiation. Since the penetration depth of microwaves that used for irradiation and the like are changed by changing the composition of the second heat generating member, if the composition of the second heat generating member is selected, absorption, by the second heat generating member, of microwaves with which the second heat generating member is irradiated can be reduced, the amount of microwaves that are transmitted through the second heat generating member can be increased, and thus the treatment target 2 can be heated at intensity that is higher than that at the second heat generating member. In this case, the treatment target 2 can be heated from the outside as well through heat generation at the second heat generating member.

It is also possible that the material of one or more of the multiple heat generating members 30 is different from that of the other heat generating members 30. Accordingly, microwaves that are absorbed by the heat generating members 30 can be changed according to the material of the heat generating members 30, and thus the heating of the heat generating members 30 through the first microwave irradiation, and the ratio of the heating of the heat generating members 30 can be changed. The same applies to the second microwave irradiation using the second heat generating members 30. The same applies to the description below.

It will be appreciated that the combination of the materials and the thicknesses of the heat generating members 30 and the second heat generating members may be changed.

In the description above, the example was described in which the treatment target 2 moves, but it is also possible that the treatment target 2 does not move inside the vessel 10 and the treatment target 2 is let to stand inside the vessel 10. The same applies to other embodiments. If the movement is not necessary, the conveying units 60 may be omitted. It is also possible that one or more irradiating portions (not shown) included in the microwave irradiating unit 20 each irradiate both of the portions in which the heat generating members 30 are provided and the treatment target 2 in the portions in which the heat generating members 30 are not provided with microwaves. This configuration may be considered as, for example, a configuration in which one or more irradiating portions (not shown) included in the microwave irradiating unit 20 each perform both of the first microwave irradiation and the second microwave irradiation. In this case, the irradiating portions are provided, for example, at positions from which one or more heat generating members 30 and one or more portions in which the heat generating members 30 are not provided on the movement path 2a can be irradiated with microwaves. For example, it is also possible that the irradiating portions are provided near the boundary or the like between the heat generating members 30, and the portions that are adjacent to the heat generating members 30 and are on the movement path 2a in which the heat generating members 30 are not provided. Examples of the irradiating portions in this case include irradiating portions similar to the first irradiating portions 201 and the second irradiating portions 202 described above.

### First Modified Example

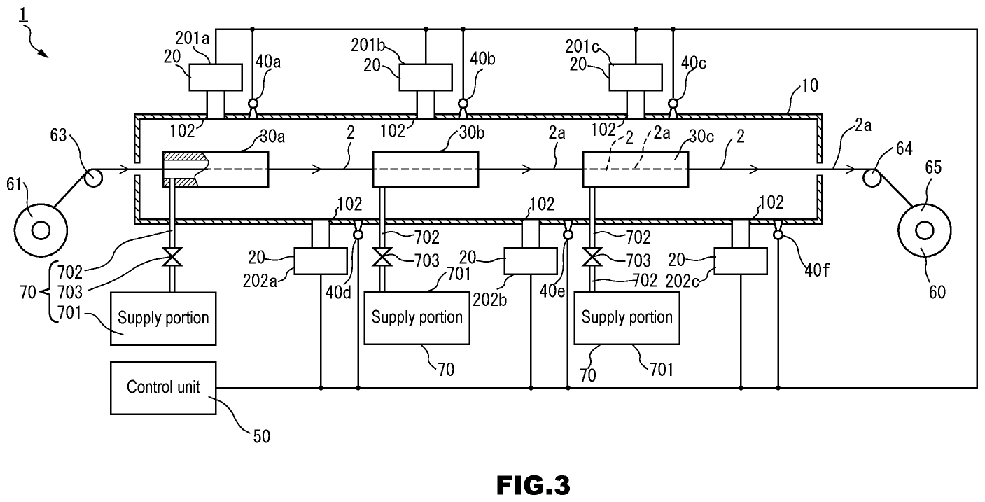

FIG. 3 is a view showing a first modified example of the microwave treatment apparatus 1 of this embodiment. The microwave treatment apparatus 1 of the first modified example is the microwave treatment apparatus 1 including the heat generating members 30 in the shape of tubes, further including gas supply units 70 that supply oxygen into the heat generating members 30. Each of the gas supply units 70 includes a supply portion 701 that supplies oxygen, such as an oxygen cylinder or an oxygen generator, a tube 702 through which oxygen is supplied, wherein, for example, one end of the tube 702 is attached to a heat generating member 30 so as to be open inside the heat generating member 30, and the other end is connected to the supply portion 701, and a valve 703 that adjusts the amount of oxygen that is supplied, and that is inserted on the path of the tube 702. There is no limitation on the position at which an end of the tube 702 is attached to the heat generating member 30. For example, the valve 703 may be controlled by the control unit 50 or the like, or controlled according to an operation by a user or the like. The operation that supplies oxygen in this case is, for example, a concept that encompasses an operation that supplies gas containing oxygen at a higher concentration than gas in the vessel 10 such as air (e.g., gas obtained by adding oxygen to air) or the like. It is also possible that multiple gas supply units 70 use one supply portion 701. If an external supply portion (not shown) or the like is used instead of the supply portions 701, the gas supply units 70 do not have to include the supply portions 701.

In order to suppress leakage of oxygen supplied into the heat generating member 30, to the outside of the heat generating member 30, two ends through which the treatment target 2 enters and exits the heat generating member 30 may be blocked except for opening portions through which the treatment target 2 can pass.

Furthermore, in this example, the case was described in which the gas supply units 70 are respectively provided for all of the multiple heat generating members 30, but it is also possible that the gas supply units 70 are provided only for some of the multiple heat generating members 30.

If oxygen is supplied by the gas supply units 70 into the heat generating members 30 in this manner, it is possible to properly control treatment that is performed in the microwave treatment apparatus 1, by controlling the oxygen concentration. For example, it is possible to facilitate shortening the treatment time or performing uniform treatment, by supplying oxygen according to treatment targets.

The configuration in which such gas supply units 70 may be provided applies to other embodiments wherein the microwave treatment apparatus includes a heat generating member in the shape of a tube or the like.

Furthermore, in the description above, it is also possible that the gas supply units 70 supply predetermined gas other than oxygen. Examples of the predetermined gas include nitrogen gas, noble gas such as argon gas, hydrogen gas, and combination of one or more of these gases. The operation that supplies predetermined gas in this case is, for example, a concept that encompasses an operation that supplies gas containing predetermined gas at a higher concentration than gas in the vessel 10 such as air (e.g., gas obtained by adding predetermined gas to air) or the like. The configuration of the gas supply units 70 is, for example, similar to the configuration described above, except that the gas that is supplied by the supply portion 701 is predetermined gas. If the vessel 10 is filled with gas other than air, the gas that is supplied by the supply portion 701 may be air. The gases that are respectively supplied by the gas supply units 70 connected to different heat generating members 30 may be the same gas, or may be different gases. The gases that are respectively supplied by the gas supply units 70 connected to different heat generating members 30 may be gases at different predetermined concentrations, or may be gases with different composition ratios.

### Second Modified Example

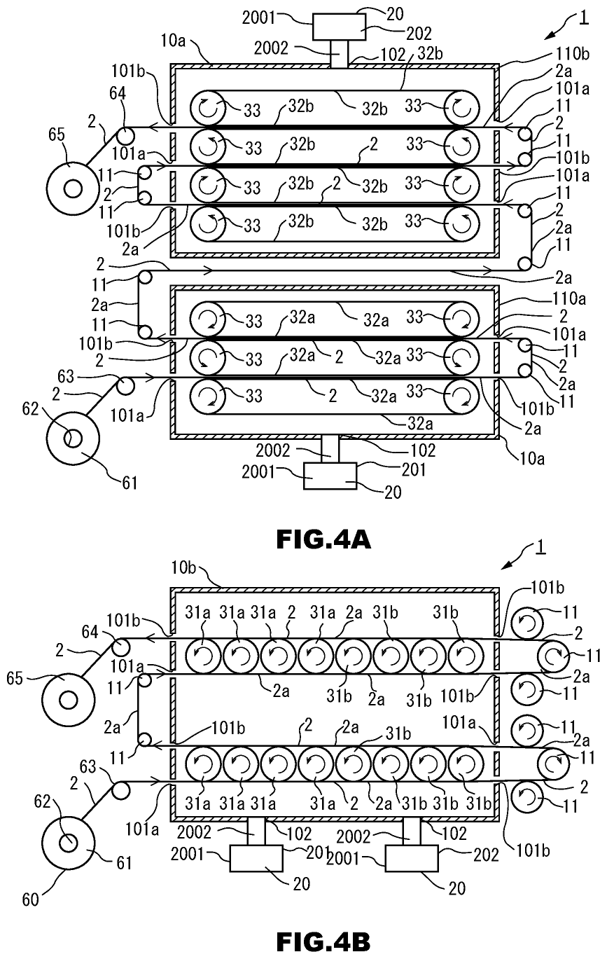

FIGS. 4A and 4B are views showing a second modified example of the microwave treatment apparatus 1 of this embodiment. As shown in FIGS. 4A and 4B, the microwave treatment apparatus 1 of this second modified example includes a member such as a roller or a belt having a heating medium, as a heat generating member, instead of the heat generating members 30, the heating medium being a member that assists conveyance of the treatment target 2 inside the vessel, having a portion that comes into contact with treatment target 2, and being configured to generate heat by absorbing microwaves at the portion that comes into contact with the treatment target 2. In FIGS. 4A and 4B, vessels 10a and a vessel 10b are vessels corresponding to the vessel 10. Although a description thereof has been omitted, it is also possible that the microwave treatment apparatus 1 according to the modified example shown in FIGS. 4A and 4B includes a control unit that is similar to the control unit 50 or sensors that are similar to the sensors 40 shown in FIG. 1, and performs feedback control on the power of microwaves and the like according to the output of the sensors.

For example, in FIG. 4A, the movement path 2a is a path that is folded back in the form of multiple layers at multiple rollers 11 that are provided outside the vessels 10a, and the vessels 10a have shapes that cover portions other than the folded portions of the movement path 2a, and have multiple inlets 101a and outlets 101b via which the treatment target 2 can enter and exit the vessels 10a, near the folded portions of the movement path 2a. There is no limitation on the size and the like of the rollers 11. In FIG. 4, the vessels 10a have two cavities 110a and 110b provided so as to partition the movement path 2a into multiple areas, and the multiple inlets 101a and the outlets 101b are provided as opening portions through which the treatment target 2 can enter and exit the cavities 110a and 110b.

In the cavity 110a, multiple belts 32a having heat generating members whose surface includes a heating medium as described above span between rollers 33 so as to hold and be in contact with the treatment target 2 that moves along the movement path 2a, for example, from above and below. It is assumed that the material of the belts 32a is, for example, a material that partially transmit microwaves. Furthermore, the first irradiating portions 201 described above are provided so as to irradiate the portions that are held between the belts 32a along the movement path 2a with microwaves. For example, the belts 32 move in the movement direction of the movement path 2a adjacent thereto, in accordance with the rotation of the rollers 33 by a motor or the like. The belts 32a may be belt that are entirely heated by microwaves. For example, a material containing a heating medium as described above and the like may be used as the material of the belts 32a. Examples of the material of the belts 32a include heat-resistant resins, graphite fibers, and the like. The heating medium on the surface of the belts 32a may be made of a heating element such as carbon, SiC, a carbon fiber composite material, a metal silicide (e.g., molybdenum silicide or tungsten silicide), or a ceramic material containing a powder or the like of these heating elements, or the like.

Furthermore, in the cavity 110b, multiple belts 32b span between rollers 33 so as to hold and be in contact with the treatment target 2 that moves along the movement path 2a, for example, from above and below. The belts 32b is made of a material with high microwave transmission. It is assumed that the surface of the belts 32b does not have a heating medium as described above. Furthermore, the second irradiating portions 202 described above are provided so as to irradiate the portions that are held between the belts 32b along the movement path 2a with microwaves. For example, the belts 32b move in the movement direction of the movement path 2a adjacent thereto, in accordance with the rotation of the rollers 33 by a motor or the like.

The portions of the belts 32a and 32b holding the treatment target 2 is arranged so as to be in contact with the treatment target 2, at portions other than those near the rollers 33. It is also possible that the portions are partially not in contact with the treatment target 2.

The belts 32a come into contact with the treatment target 2, thereby assisting conveyance thereof, and preventing a breakage or non-uniform heating of the treatment target 2 caused when the treatment target 2 is loosened during treatment. In the cavity 110a, the surface of the belts 32a generates heat through microwave irradiation, and heats the treatment target near the belts 32 with radiant heat obtained through the heat generation, the first microwave irradiation as described above is performed by the first irradiating portions 201, and the portion of the treatment target 2 that comes into contact with the belt 32 can be efficiently heated through heat conduction.

Furthermore, as in the case of the belts 32a, the belts 32b come into contact with the treatment target 2, thereby assisting conveyance thereof, and preventing a breakage or non-uniform heating of the treatment target 2 caused when the treatment target 2 is loosened during treatment. In the cavity 110b, the surface of the belts 32b hardly generates heat through microwave irradiation, and the treatment target 2 is directly heated by microwaves transmitted through the belts 32b, and thus the second microwave irradiation as described above is performed by the second irradiating portions 202.

It is also possible to omit the belts 32b instead of using the belts 32b, and to perform the second microwave irradiation by which the portions in which the belts 32b are omitted are irradiated with microwaves.

Furthermore, in this example, the case was described in which the vessel 10 includes two cavities 110a and 110b, it is sufficient that the number of cavities included in the vessel 10 is one or at least two, and there is no limitation on the numbers thereof. Also, there is no limitation on the size and the like of each cavity. There is no limitation on the number of cavities internal portion of which is irradiated with microwaves by the first irradiating portions 201 and cavities internal portion of which is irradiated with microwaves by the second irradiating portions 202, the order in which the cavities are provided along the movement path 2a, and the like. The multiple cavities included in the vessel 10 may be arranged so as to be connected to each other, or arranged so as to be separate from each other. For example, multiple cavities that are arranged so as to be connected to each other or multiple cavities that are arranged so as to be separate from each other in order to the above-described treatment on the same treatment target 2 may be considered as one vessel 10. Also, the treatment target 2 that has been moved from one cavity to the outside may be returned to the same cavity. The configuration in which the vessel 10 may include two or more cavities applies to microwave treatment apparatuses other than the microwave treatment apparatus shown in FIG. 4A.

Furthermore, the microwave treatment apparatus 1 shown in FIG. 4A may be configured such that a vessel that is not partitioned into multiple cavities is used as the vessel 10, one or more belts 32a and 32b as described above are provided in the vessel 10, one or more first irradiating portions 201 perform first microwave irradiation to the belts 32a, and one or more second irradiating portions 202 perform second microwave irradiation to the belts 32b.

The above-described shape of the vessels 10a and the movement path 2a in this case are merely an example, and the shape of the vessel 10 and the movement path of the treatment target 2 may be any shape and any movement path.

Furthermore, for example, as shown in FIG. 4B, it is also possible that multiple rollers 31a whose surface includes a heating medium are arranged such that the surface is in contact with the treatment target 2 that moves along the movement path 2a, multiple rollers 31b whose surface has no heating member, and that hardly absorb microwaves are arranged such that the surface is in contact with the treatment target 2 that moves along the movement path 2a, at areas that are different from the areas in which the multiple rollers 31a are provided, a first irradiating portion 201 that irradiates the areas in which the multiple rollers 31a are provided on the movement path 2a with microwaves is provided, a second irradiating portion 202 that irradiates the areas in which the rollers 31b are provided on the movement path 2a with microwaves is provided, and the first irradiating portions 201 and the second irradiating portions 202 perform irradiation with microwaves. The rollers 31a may be rollers that are entirely heated by microwaves. For example, a material containing a heating medium as described above and the like may be used as the material of the rollers 31a. Examples of the material of the rollers 31a include heat-resistant resins, ceramics, glasses, graphites, and the like. The heating medium on the surface of the belts 32a may be made of a heating element such as carbon, SiC, a carbon fiber composite material, a metal silicide (e.g., molybdenum silicide or tungsten silicide), or a ceramic material containing a powder or the like of these heating elements, or the like.

For example, in FIG. 4B, the movement path 2a is a path that is folded back in the form of multiple layers at multiple rollers 11 that are provided outside the vessel 10a, and the vessel 10a has a shape that covers portions other than the folded portions of the movement path 2a, and has multiple inlets 101a and outlets 101b via which the treatment target 2 can enter and exit the vessel, near the folded portions of the movement path 2a. There is no limitation on the size and the like of the rollers 11.

The multiple rollers 31a come into contact with the treatment target 2, thereby assisting conveyance thereof, and preventing a breakage or non-uniform heating of the treatment target 2 caused when the treatment target 2 is loosened during treatment. The multiple rollers 31a are used as heating members described above, their surface generates heat through microwave irradiation, and heats the treatment target near roller 31 with radiant heat obtained through the heat generation, and the portion of the treatment target 2 that comes into contact with roller 31 can be efficiently heated through heat conduction. Accordingly, the microwave irradiation that is performed by the first irradiating portions 201 is the first microwave irradiation.

The multiple rollers 31b come into contact with the treatment target 2, thereby assisting conveyance thereof, and preventing a breakage or non-uniform heating of the treatment target 2 caused when the treatment target 2 is loosened during treatment. The multiple rollers 31b hardly generate heat through microwave irradiation, and the treatment target 2 is directly heated by microwaves transmitted through the rollers 31b, and thus the second microwave irradiation as described above is performed by the second irradiating portions 202.

The rollers 31a and the rollers 31b may or may not be connected to a motor (not shown) or the like and be caused to rotate by themselves. It is sufficient that the number of rollers 31a and rollers 31b is one or more.

It is also possible to omit the rollers 31b instead of using the rollers 31b, and to perform the second microwave irradiation by which the portions in which the rollers 31b are omitted are irradiated with microwaves.

Also, the arrangement, the arrangement order, and the like of the rollers 31a and the rollers 31b may be arrangements and arrangement orders other than those described above. There is no limitation on the numbers of rollers 31a and rollers 31b.

Furthermore, it is also possible that a vessel including multiple cavities as shown in FIG. 4A may be used instead of the vessel 10b shown in FIG. 4B. For example, it is also possible that the first irradiating portions 201 or the second irradiating portions 202 are attached to each cavity, the rollers 31a are provided in the cavity to which the first irradiating portions 201 are attached, and the rollers 31b are provided in the cavity to which the second irradiating portions 202 are attached.

### Embodiment 2

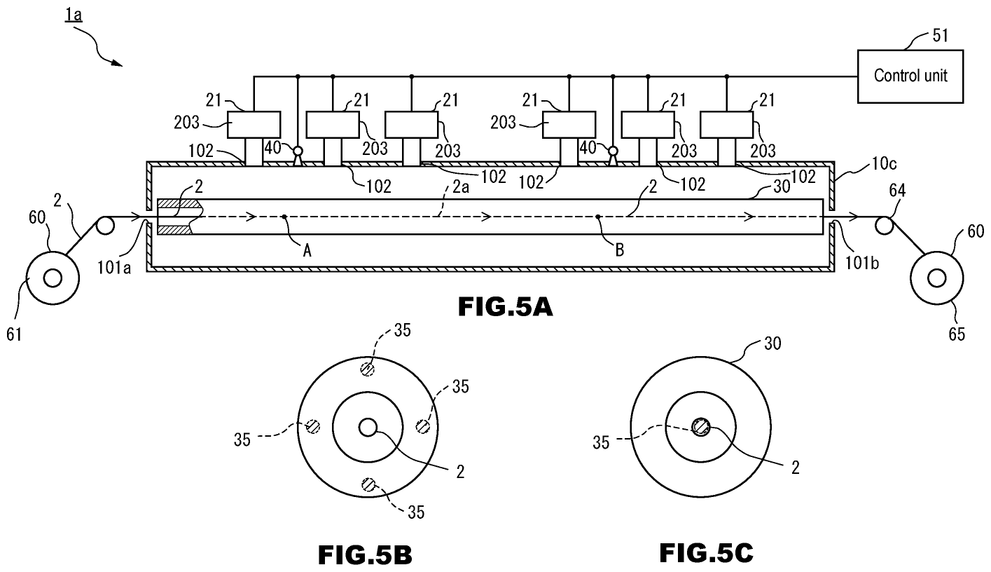

FIG. 5 shows a cross-sectional view that is parallel to the movement direction of a treatment target, illustrating the microwave treatment apparatus in this embodiment (FIG. 5A), a schematic cross-sectional view that is perpendicular to the longitudinal direction that passes through the point Ain FIG. 5A in the heat generating member of the microwave treatment apparatus (FIG. 5B), and a schematic cross-sectional view that is perpendicular to the longitudinal direction that passes through the point B in the heat generating member of the microwave treatment apparatus (FIG. 5C). A microwave treatment apparatus 1a of this embodiment performs the first microwave irradiation and the second microwave irradiation, by controlling multiple phases of microwaves that are output by the microwave irradiating unit 21 from different positions.

The microwave treatment apparatus 1a includes a vessel 10c, a microwave irradiating unit 21, a heat generating member 30, one or at least two sensors 40, a control unit 51, and conveying units 60.

The vessel 10c is the same as the vessel 10 shown in FIG. 1 in the foregoing embodiment, except that later-described two or more irradiating portions 203 included in the microwave irradiating unit 21 are attached. the vessel 10c may be a vessel as described in the foregoing embodiment, and examples thereof include a vessel including multiple cavities.

Hereinafter, a case will be described in which the heat generating member 30 in the shape of one tube is provided along the movement path 2a of the treatment target 2 in the vessel 10c. Note that there may be multiple heat generating members 30. The heat generating member 30 may be the heat generating member 30 as described in the foregoing embodiment.

The microwave irradiating unit 21 includes two or more irradiating portions 203 that perform irradiation with microwaves from different positions. For example, the microwave irradiating unit 21 includes two or more irradiating portions 203 that are attached to the opening portions 102 that are formed at different positions through the wall face of the vessel 10c, and irradiates the internal portion of the vessel 10c with microwaves. At least some of the two or more irradiating portions 203 are irradiating portions 203 that can control the phases of microwaves that used for irradiation. For example, the irradiating portions 203 that can control the phases are each an irradiating portion 203 that includes a microwave oscillator 2001 and a transmitting portion 2002 as described in the foregoing embodiment, further including a phase shifter (not shown) that can control the phases. The microwave oscillators 2001 that are included in the irradiating portions 203 that can control the phases are preferably semiconductor oscillators. The irradiating portions 203 that do not control the phases may be irradiating portions that are similar to the first irradiating portions 201 or the second irradiating portions 202 the foregoing embodiment. Note that the irradiating portions 203 that can control the phases of microwaves that used for irradiation may have any configuration, as long as the phases can be controlled. The operation that controls the phases in this case may be considered as including an operation that sets the phases to a specific phase.

The microwave treatment apparatus 1a of this embodiment controls the phases of microwaves that are used for irradiation by the two or more irradiating portions 203, thereby performing first microwave irradiation in which microwaves that are used for irradiation by the two or more irradiating portions 203 are intensified by each other at the heat generating member 30, and second microwave irradiation in which microwaves that are used for irradiation by the two or more irradiating portions 203 are intensified by each other at the treatment target 2. For example, the microwave treatment apparatus 1a controls the phases of microwaves that are used for irradiation by each of the irradiating portions 203, using a later-described control unit 51 or the like, thereby performing the first microwave irradiation and the second microwave irradiation. The state in which microwaves are intensified by each other is, for example, a state in which intensities of microwaves are increased by each other. For example, the state in which microwaves are intensified by each other may be a state in which electric field intensities of microwaves are increased by each other, a state in which magnetic field intensities are increased by each other, or a state in which both types of intensities are increased by each other. For example, the microwave treatment apparatus 1a controls the phases of microwaves that are used for irradiation by the two or more irradiating portions, using the control unit 51 or the like, thereby causing the phases of microwaves used for irradiation by the irradiating portions to be intensified by each other at a given position through an interference. For example, the microwave treatment apparatus 1a controls the phases of microwaves that are used for irradiation by the two or more irradiating portions, using the control unit 51 or the like, thereby causing microwaves used for irradiation by the irradiating portions to have the same phase at a given position, so as to be intensified by each other. The operation that causes microwaves to be intensified by each other at a given position may be considered as an operation that causes microwaves to be concentrated at a given position. The microwave treatment apparatus 1a causes microwaves not to be intensified by each other at a given position through an interference, thereby causing the microwaves not to be intensified by each other. The microwave treatment apparatus 1a causes microwaves not to have the same phase at a given position, for example, to have opposite phases, so as not to be intensified by each other. If all microwaves that are used for irradiation by the irradiating portions 203 have the same frequency, for example, it is possible to cause microwaves used for irradiation from multiple positions to be intensified by each other at a given position in the following manner: the distance between the given position and each position from which irradiation with microwaves is performed is divided by the microwave wavelength, a remainder thereof is further divided by the microwave wavelength and multiplied by 2π to obtain a value, and the phase is advance by that value relative to the reference phase. Note that there is no limitation on the manner how microwave phases are controlled to cause the microwaves to have the same phase at a given position. The processing that controls microwave phases, thereby increasing intensity of microwaves at a given position is known, for example, in JP 2017-212237A and the like, and thus a detailed description thereof has been omitted.

The first microwave irradiation that is performed by controlling the phases of microwaves that are used for irradiation by the two or more irradiating portions 203 is, for example, performing irradiation from multiple positions in the vessel 10c, with microwaves whose phases are controlled such that microwaves are not intensified by each other at a given position on the treatment target 2, and microwaves are intensified by each other at one or more portions on the heat generating member 30, around the given position. The one or more portions around the given position on the treatment target 2 are one or more portions that are in a direction that is perpendicular to the extending direction of the treatment target 2 or the movement direction of the treatment target 2. The given position on the treatment target 2 is, for example, a given position on the movement path 2a of the treatment target 2. The same applies to the description below. The first microwave irradiation in this case may be, for example, performing irradiation from multiple positions in the vessel 10c, with microwaves whose phases are controlled such that the intensity of microwaves at one or more portions on the heat generating member 30, around the given position, is higher than the intensity of microwaves at the given position on the treatment target 2. The one or more portions around the given position are, for example, one or more portions on the heat generating member 30, the portions intersecting a virtual face that is perpendicular to the traveling direction of the movement path 2a, at the given position on the movement path 2a of the treatment target 2. The first microwave irradiation in this case may be, for example, performing irradiation from multiple positions in the vessel 10c, with microwaves whose phases are controlled such that microwaves are intensified by each other at the given position on the treatment target 2, and performing irradiation from multiple positions in the vessel 10c that are different from the above-mentioned multiple positions, with microwaves whose phases are controlled such that microwaves are intensified by each other at one or more portions on the heat generating member 30, around the given position, wherein the power of microwaves that are output with their phases being controlled such that the microwaves are intensified by each other at the heat generating member 30 is set higher than the power of microwaves that are output with their phases being controlled such that the microwaves are intensified by each other at the treatment target 2.

Furthermore, the second microwave irradiation that is performed by controlling the phases of microwaves that are used for irradiation by the two or more irradiating portions 203 is, for example, performing irradiation from multiple positions in the vessel 10c, with microwaves whose phases are controlled such that microwaves are intensified by each other at a given position on the treatment target 2, and microwaves are not intensified by each other at the heat generating member 30, around the given position. The second microwave irradiation in this case may be, for example, performing irradiation from multiple positions in the vessel 10c, with microwaves whose phases are controlled such that the intensity of microwaves at the given position on the treatment target 2 is higher than the intensity of microwaves at one or more portions on the heat generating member 30, around the given position. The second microwave irradiation in this case may be, for example, performing irradiation from multiple positions in the vessel 10c, with microwaves whose phases are controlled such that microwaves are intensified by each other at the given position on the treatment target 2, and performing irradiation from multiple positions in the vessel 10c that are different from the above-mentioned multiple positions, with microwaves whose phases are controlled such that microwaves are intensified by each other at one or more portions on the heat generating member 30, around the given position, wherein the power of microwaves that are output with their phases being controlled such that the microwaves are intensified by each other at the treatment target 2 is set higher than the power of microwaves that are output with their phases being controlled such that the microwaves are intensified by each other at the heat generating member 30.

There is no limitation on the positions at which microwaves are intensified by each other by performing the first microwave irradiation in this case, the number of positions at which microwaves are intensified by each other, the positions at which microwaves are intensified by each other by performing the second microwave irradiation, the number of positions at which microwaves are intensified by each other, or the like. It is also possible that the positions and the number of positions are set as appropriate according to results of experiments or simulations that are performed on the treatment target 2 or the like.

Furthermore, the two or more irradiating portions 203 that perform the first microwave irradiation and the two or more irradiating portions 203 that perform second microwave irradiation may be the same irradiating portions 203 or may be different irradiating portions 203, or only some of them are the same irradiating portions 203. Also, microwaves that are used for irradiation by the two or more irradiating portions 203 that perform the first microwave irradiation and microwaves that are used for irradiation by the two or more irradiating portions 203 that perform second microwave irradiation may be the same frequency, or may be different frequencies.

The one or at least two sensors 40 are, for example, the same as the sensors in the foregoing embodiment. The sensors 40 are provided, for example, near the positions at which the first microwave irradiation is performed or near the positions at which the second microwave irradiation is performed in the vessel 10c.

The conveying units 60 are the same as those in the foregoing embodiment, and thus a detailed description thereof has been omitted.

The control unit 51 controls the phases of microwaves that are used for irradiation by the microwave irradiating unit 21 from multiple positions. The operation that controls the phases of microwaves that are used for irradiation by multiple positions may be considered as a concept that encompasses an operation that does not control one or more microwave phases serving as a reference, but controls other microwave phases. As described above, the control unit 51 controls the phases of microwaves that are used for irradiation by the microwave irradiating unit 21 such that the first microwave irradiation is performed at one or at least two given positions on the movement path 2a of the treatment target 2, and the second microwave irradiation is performed at one or at least two given positions on the movement path 2a of the treatment target 2, the positions being different from the above-mentioned positions at which the first microwave irradiation is performed. For example, the phases of microwaves that are respectively used for irradiation by the multiple irradiating portions 203 are controlled such that the first microwave irradiation and the second microwave irradiation are performed in this manner. The control unit 51 may individually control the power of microwaves that are used for irradiation by the microwave irradiating unit 21 from multiple positions. For example, the control unit 51 may individually control the power of microwaves that are used for irradiation by the irradiating portions 203. For example, the control unit 51 performs feedback control on the power of the irradiating portions 203 that perform the first microwave irradiation at a given position, according to the information of temperature or the like output by the sensors 40 provided near the given position. For example, the control unit 51 performs feedback control on the power of the irradiating portions 203 that perform the second microwave irradiation at a given position, according to the information of temperature or the like output by the sensors 40 provided near the given position. Note that it is also possible to perform control other than the feedback control.

If the phases do not have to be changed after the phases of the irradiating portions 203 are once set such that microwaves are intensified by each other at one or at least two given positions, or if the phases of the irradiating portions 203 are manually set, for example, the control unit 51 does not have to control the phases of microwaves that are used for irradiation by the irradiating portions 203, and the control unit for controlling the phases does not have to be provided.

Next, an operation of the microwave treatment apparatus 1a of this embodiment will be described by way of a specific example. In this example, a case will be described as an example in which flame-resistance treatment on a PAN-based precursor fiber that is the treatment target 2 is performed using the microwave treatment apparatus 1a. Hereinafter, for the sake of convenience of description, a description will be given using the microwave treatment apparatus 1a shown in FIG. 5A.

In this example, it is assumed that the treatment target 2 is moved by the conveying units 60 along the movement path 2a, the first microwave irradiation is performed on the point A on the movement path 2a of the treatment target 2 shown in FIG. 5, and the second microwave irradiation is performed on the point B. Specifically, the control unit 51 controls the multiple irradiating portions 203, thereby causing the multiple irradiating portions 203 to perform irradiation with microwaves whose phases are controlled such that microwaves are not intensified by each other at the point A on the movement path 2a of the treatment target 2, and microwaves are intensified by each other at one or more portions on the heat generating member 30, around the point A. In this case, for example, it is assumed that irradiation with microwaves is performed such that the microwaves are intensified by each other at the point A from those attached on the inlet 101a side, corresponding to a half of the multiple irradiating portions 203. That is to say, it is assumed that the first microwave irradiation is performed by those attached on the inlet 101a side, corresponding to a half of the multiple irradiating portions 203. The control unit 51 controls the multiple irradiating portions 203, thereby causing the multiple irradiating portions 203 to perform irradiation with microwaves whose phases are controlled such that microwaves are intensified by each other at the point B on the movement path 2a of the treatment target 2, and microwaves are not intensified by each other at one or more portions on the heat generating member 30, around the point B. In this case, for example, it is assumed that irradiation with microwaves is performed such that the microwaves are intensified by each other at the point B from those attached on the outlet 101b side, corresponding to a half of the multiple irradiating portions 203. That is to say, it is assumed that the second microwave irradiation is performed by those attached on the outlet 101b side, corresponding to a half of the multiple irradiating portions 203. It is also possible that the first microwave irradiation and the second microwave irradiation are performed also at portions other than the points A and B above.

At the point A, the first microwave irradiation is performed, and thus points 35 at which microwaves are intensified by each other appear at multiple points (e.g., four points in this example) on the heat generating member 30 as shown in FIG. 5B. The heat generating member 30 generates heat due to the microwaves that are intensified by each other at the points 35, and the treatment target 2 is heated from the outside by radiant heat of the heat generating member 30. At the point A, the treatment target 2 is directly heated as well by microwaves, unless multiple microwaves that are used for irradiation by the multiple irradiating portions 203 completely cancel each other to be “0”. However, this is not a point at which multiple microwaves are intensified by each other, and thus the amount of heat generated is small.

Furthermore, at the point B, the second microwave irradiation is performed, and thus a point 35 at which microwaves are intensified by each other appears at the treatment target 2 as shown in FIG. 5C. The treatment target 2 is directly heated by the microwaves that are intensified by each other at the points 35. Around the point B, the heat generating member 30 generates heat as well due to the microwaves, unless multiple microwaves that are used for irradiation by the multiple irradiating portions 203 are completely cancel each other to be “0”, and the treatment target 2 is heated from the outside as well through heat generation. However, this is not a point at which multiple microwaves are intensified by each other, and thus the amount of heat generated is small.

If the control unit 51 performs feedback control on the multiple irradiating portions 203 at which the first microwave irradiation is performed onto the point A, according to the temperature acquired by the sensors 40 provided near the point A, it is possible to increase or decrease the power of microwaves that are intensified by each other at the heat generating member 30 around the point A, and to perform heating at a desired temperature to the treatment target 2 at the point A. Also, if the control unit 51 performs feedback control on the multiple irradiating portions 203 at which the second microwave irradiation is performed onto the point B, according to the temperature acquired by the sensors 40 provided near the point B, it is possible to increase or decrease the power of microwaves that are intensified by each other at the point B on the treatment target 2, and to perform heating at a desired temperature to the treatment target 2 at the point B.

For example, as described in the foregoing embodiment, at or near the position corresponding to the heat generation peak at the treatment target 2, if the first microwave irradiation is performed while controlling the phases such that microwaves are intensified by each other at the heat generating member 30 therearound, and are not intensified by each other at the treatment target 2 in a way similar to that at the point A described above, it is possible to properly treat the treatment target 2 while avoiding abrupt heating when the treatment target 2 reaches its heat generation peak. Also, at other positions, for example, if irradiation with microwaves is performed such that the microwaves are intensified by each other at the treatment target 2, it is possible to efficiently heat the treatment target 2 mainly through direct heating with microwaves, and to improve the treatment speed. At other positions, for example, if irradiation with microwaves is performed such that the microwaves are intensified by each other at the treatment target 2 or such that the microwaves are intensified by each other at the heat generating member 30, it is possible to properly perform, in a switchable manner, the first microwave irradiation and the second microwave irradiation on the treatment target 2 that moves, and to perform uniform heating and desired heating of the treatment target 2.

The arrangement of the multiple irradiating portions 203 in this specific example is merely an example, and there is no limitation on the arrangement or the number of the multiple irradiating portions 203.

Furthermore, there is no limitation on the set number or the arrangement of each of points such as the point A at which microwaves are intensified by each other at the heat generating member 30, points such as the point B at which microwaves are intensified by each other at the treatment target 2, and points at which microwaves are intensified by each other at both of the heat generating member 30 and the treatment target 2, on the movement path 2a of the treatment target 2 in the vessel 10c. In the microwave treatment apparatus 1a, for example, with respect to the movement path 2a, it is sufficient that at least one or more points at which microwaves are intensified by each other at the heat generating member 30, and at least one or more points at which microwaves are intensified by each other at the treatment target 2 are set on the movement path 2a.

As described above, according to this embodiment, it is possible to properly treat the treatment target 2 using microwaves, by controlling multiple phases of microwaves that are used for irradiation by the microwave irradiating unit 21 from different positions, thereby performing the first microwave irradiation in which two or more microwaves are intensified by each other at the heat generating member 30 and the second microwave irradiation in which two or more microwaves are intensified by each other at the treatment target 2. For example, it is possible to perform proper heating, by controlling the combination and the ratio between heating of a treatment target from the outside by a heat generating member caused to generate heat by microwaves, and the directly heating the treatment target with microwaves.

In the description above, feedback control on the power of microwaves that used for irradiation is performed according to the information of temperature and the like acquired by the sensors 40, but it is also possible to control the heating of the treatment target 2, by controlling control the phases of microwaves that are used for irradiation by the microwave irradiating unit 21, according to the information of temperature acquired by one or more sensors 40, thereby moving the positions at which microwaves are intensified by each other through the first microwave irradiation or the second microwave irradiation along the movement path 2a of the treatment target 2. For example, in the description above, when the temperature at the point B acquired by the sensor 40 is high, it is also possible to delay the time to perform heating through the second microwave irradiation, by moving the position of the point B.

Furthermore, in the description above, it is also possible that the first microwave irradiation by which irradiation with microwaves is performed such that the microwaves are intensified by each other at the heat generating member 30 and the second microwave irradiation by which irradiation with microwaves is performed such that the microwaves are intensified by each other at the treatment target 2 are simultaneously performed at the same position on the movement path 2a of the treatment target 2. In this case, the power of microwaves in the first microwave irradiation and the power of microwaves in the second microwave irradiation may be different from each other.

Furthermore, in the foregoing embodiment, the case was described as an example in which the treatment target 2 moves inside the vessel 10c, but it is also possible that the treatment target 2 does not move inside the vessel 10c, and the positions at which the heat generating member 30 is heated and the positions at which the treatment target 2 is directly heated are changed over time, by controlling multiple phases of microwaves with which the internal portion of the vessel 10c is irradiated, thereby changing over time the positions at which microwaves are intensified by each other through the first microwave irradiation at the heat generating member 30, and the positions at which microwaves are intensified by each other through the second microwave irradiation at the treatment target 2. With this configuration, for example, it is possible to perform proper heating of the treatment target 2.

In the foregoing embodiment, if the phases of microwaves that are used for irradiation by the microwave irradiating unit 21 from the multiple irradiating portions 203 are controlled, it is preferable to design the vessel 10c such that a first microwave irradiation position at which microwaves that are used for irradiation by the irradiating portions 203 are intensified in the heat generating member 30, and a second microwave irradiation position at which microwaves that are used for irradiation by the irradiating portions 203 are intensified in the treatment target 2 are provided along the movement path 2a of the treatment target 2.

Furthermore, in the foregoing embodiment, it is also possible that the phases of microwaves that are used for irradiation by the microwave irradiating unit 21 from the multiple irradiating portions 203 are not controlled. For example, if the microwave irradiating unit 21 includes one or more irradiating portions 203 that perform irradiation with microwaves, it is also possible to, instead of controlling the phases of microwaves that are used for irradiation by each of the irradiating portions 203, design the vessel 10c such that a first microwave irradiation position at which microwaves that are used for irradiation by the irradiating portions 203 are intensified in the heat generating member 30, and a second microwave irradiation position at which microwaves that are used for irradiation by the irradiating portions 203 are intensified in the treatment target 2 are provided along the movement path 2a of the treatment target 2.

### Modified Examples

In the microwave treatment apparatus 1a of Embodiment 2, it is also possible that one or at least two heat generating members 30 are provided inside the vessel 10c along part of the movement path 2a of the treatment target 2 as in Embodiment 1 described above, and the control unit 51 or the like controls the phases of microwaves that are respectively used for irradiation by two or more irradiating portions 203 that perform irradiation with microwaves from different positions, thereby providing a first microwave irradiation position at which microwaves that are used for irradiation by the irradiating portions 203 are intensified in the heat generating members 30, a second microwave irradiation position at which microwaves that are used for irradiation by the irradiating portions 203 are intensified in the treatment target in a portion in which the heat generating member is not provided, and a third microwave irradiation position at which microwaves that are used for irradiation by the irradiating portions 203 are intensified in the treatment target in a portion in which the heat generating member is provided.

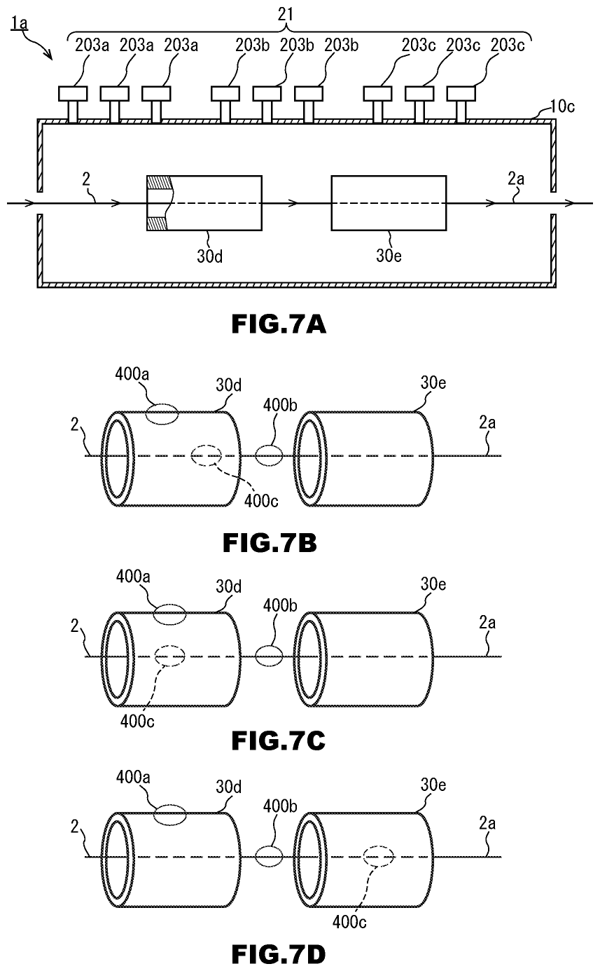

FIG. 7A is a schematic cross-sectional view that is parallel to the movement direction of a treatment target, illustrating an example of a modified example of the microwave treatment apparatus 1a. This microwave treatment apparatus 1a is the microwave treatment apparatus 1a of Embodiment 2, wherein heat generating members 30d and 30e that are two heat generating members are provided inside the vessel 10c at a predetermined interval along part of the movement path 2a of the treatment target 2 so as to cover the treatment target 2, and the microwave irradiating unit 21 includes, as the two or more irradiating portions 203, three irradiating portions 203a, three irradiating portions 203b, and three irradiating portions 203c that perform irradiation with microwaves from different positions. The three irradiating portions 203a, the three irradiating portions 203b, and the three irradiating portions 203c are each attached to the vessel 10c in a way similar to that of the irradiating portions 203 described above. The heat generating members 30d and 30e may be considered as being provided such that an area in which no heat generating member is provided is interposed therebetween. In this example, a case is shown in which the three irradiating portions 203a, the three irradiating portions 203b, and the three irradiating portions 203c are provided along the movement path 2a of the treatment target 2 sequentially from the inlet side of the vessel 10c, but the arrangement is not limited to this. For example, the irradiating portions 203 are positioned such that microwaves can be intensified by each other at one or more given positions by controlling the phases. In the drawing, the sensors, the control unit, and the like are not shown.

FIGS. 7B to 7D are schematic views showing the heat generating members 30d and 30e and the vicinity thereof in the microwave treatment apparatus shown in FIG. 7A, illustrating a position at which microwaves are intensified.

For example, in the microwave treatment apparatus 1a shown in FIG. 7A, the phases of microwaves that are respectively used for irradiation by the three irradiating portions 203a are controlled such that the microwaves are intensified at a position 400a at which the heat generating member 30d is provided in the movement direction of the treatment target 2, the phases of microwaves that are respectively used for irradiation by the three irradiating portions 203b are controlled such that the microwaves are intensified in the treatment target 2 at a position 400b between the heat generating members 30d and 30e at which the heat generating member 30e is not provided in the movement direction of the treatment target 2, and the phases of microwaves that are respectively used for irradiation by the three irradiating portions 203c are controlled such that the microwaves are intensified at a portion of the treatment target that is located inside the heat generating member 30 at a position 400c at which the heat generating member 30d is provided in the movement direction of the treatment target 2. In this example, it is assumed that the position 400a and the position 400c are different positions in the direction that is along the movement path 2a of the treatment target 2. In this example, the phases are controlled such that the position 400c is provided so as to be closer to the heat generating member 30e than the position 400a is, but it is also possible that the phases are controlled such that the position 400a is provided so as to be closer to the heat generating member 30e than the position 400c is. The phases are controlled, for example, using a control unit that is similar to the control unit 51.

When the microwave irradiating unit 21 performs irradiation with microwaves as described above, as shown in FIG. 7B, the position 400a, the position 400b, and the position 400c are positions at which the intensity of microwaves is high. Accordingly, the heat generating member 30d is heated at high intensity at the position 400a, and the treatment target 2 is heated at high intensity at the position 400b and the position 400c. It is assumed that the position 400c is a position that overlaps the treatment target 2 inside the heat generating member 30d. In this case, the position 400a corresponds to the first microwave irradiation position, the position 400b corresponds to the second microwave irradiation position, and the position 400c and the vicinity thereof correspond to the third microwave irradiation position. These positions may be considered as areas.

In this manner, if the positions at which microwaves are intensified are set to a portion in which the heat generating member 30 is provided, the treatment target 2 in a portion in which the heat generating member 30 is not provided, and the treatment target 2 in a portion in which the heat generating member 30 is provided (e.g., a portion of the treatment target 2 that is located inside the heat generating member 30), for example, it is possible to perform desired heating of the treatment target 2.

In the description above, it is also possible to perform irradiation with microwaves such that the position 400a that is the first microwave irradiation position and the position 400c that is the third microwave irradiation position are the same position in the direction that is along the movement path 2a of the treatment target as shown in FIG. 7C, by controlling the phases of microwaves that are respectively used for irradiation by the three irradiating portions 203a and the phases of microwaves that are respectively used for irradiation by the three irradiating portions 203c.

Furthermore, in the description above, it is also possible to arrange the position 400a that is the first microwave irradiation position and the position 400c that is the third microwave irradiation position, in portions in which different heat generating members 30 are provided, by controlling each of the phases of microwaves that are respectively used for irradiation by the three irradiating portions 203 and the phases of microwaves that are respectively used for irradiation by the three irradiating portions 203c. For example, as shown in FIG. 7D, it is also possible that the position 400a that is the first microwave irradiation position is provided at the heat generating member 30d, and the position 400c that is the third microwave irradiation position is provided at the heat generating member 30e.

In the description above, the case was described as an example in which the number of heat generating members 30 is two, but it is sufficient that the number of heat generating members 30 is one or more, if the first microwave irradiation position and the third microwave irradiation position are provided in a portion in which the same heat generating member 30 is provided as shown in FIGS. 7B and 7C. The lengths, materials, and the like of at least some of the two or more heat generating members 30 may be the same or different from each other.

Furthermore, it is sufficient that the number of heat generating members 30 is two or more, if the first microwave irradiation position and the third microwave irradiation position are provided in portions in which different heat generating members 30 are provided as shown in FIG. 7D.

Furthermore, the heat generating member 30 in which the first microwave irradiation position is provided and the area of the treatment target 2 in which no heat generating member is provided and in which the second microwave irradiation position is provided, may be adjacent to each other as shown in FIG. 7B, or may not be adjacent to each other.

Furthermore, if the position 400a that is the first microwave irradiation position and the position 400c that is the third microwave irradiation position are provided in portions in which different heat generating members 30 are provided, the first microwave irradiation position and the third microwave irradiation position may be heat generating members 30 that are adjacent to each other between which only one area in which no heat generating member is provided is interposed, or may be heat generating members 30 that are adjacent to each other between which two or more areas in which no heat generating member is provided are interposed.

Furthermore, there is no limitation on the number of irradiating portions 203a, as long as it is two or more. The same applies to the irradiating portions 203b and 203c. It is also possible that at least some of two or more irradiating portions 203a and two or more irradiating portions 203b are realized by the same irradiating portion. That is to say, it is also possible that at least some of two or more irradiating portions 203a are used as at least some of two or more irradiating portions 203b, and at least some of the irradiating portions 203a and at least some of the irradiating portions 203b are shared. The same applies to at least some of two or more irradiating portions 203a and two or more irradiating portions 203c, and at least some of two or more irradiating portions 203b and two or more irradiating portions 203c. In a similar manner, it is also possible that at least some of two or more irradiating portions 203a, two or more irradiating portions 203b, and two or more irradiating portions 203c are realized by the same irradiating portion. That is to say, it is also possible that at least some of two or more irradiating portions 203a are used as at least some of two or more irradiating portions 203b, and also as at least some of two or more irradiating portions 203c. It is also possible that the microwave irradiating unit 21 includes multiple sets each consisting of two or more first irradiating portions 203a. The same applies to the second irradiating portions 203b and the third irradiating portions 203c.

Furthermore, it is also possible that the microwave irradiating unit 21 performs irradiation with microwaves whose phases are controlled such that multiple first microwave irradiation positions are provided in the microwave treatment apparatus 1a. The same applies to the second and third microwave irradiation positions. It is also possible that the microwave irradiating unit 21 performs irradiation with microwaves whose phases are controlled such that multiple first microwave irradiation positions are provided in one heat generating member 30. The same applies to the second and third microwave irradiation positions.

In the description above, the first to third microwave irradiation positions are provided as described above by controlling the phases of microwaves that are used for irradiation by each of the irradiating portions 203, but it is also possible to arrange the first to third microwave irradiation positions as described above by designing the vessel 10c and the like. In this case, it is sufficient that the number of irradiating portions 203 included in the microwave irradiating unit 21 is one or more. The designing the vessel 10c and the like may be considered as designing a cavity and the like that are irradiated with microwaves. The designing the vessel 10c and the like may be considered as designing also including the arrangement of the irradiating portions 203 and the like.

### Embodiment 3

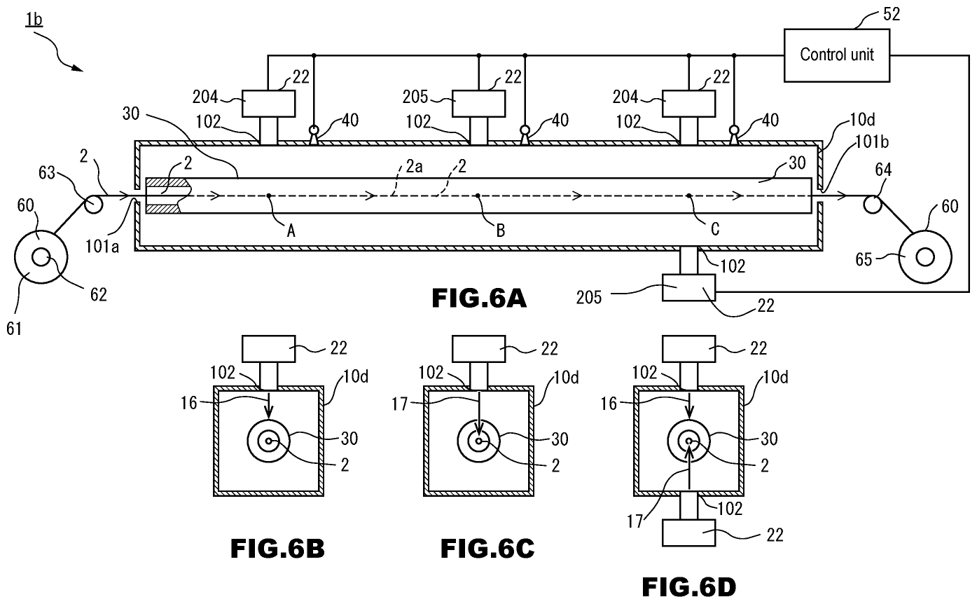

FIG. 6 shows a cross-sectional view that is parallel to the movement direction of a treatment target, illustrating the microwave treatment apparatus in this embodiment (FIG. 6A), a schematic cross-sectional view that is perpendicular to the longitudinal direction that passes through the point Ain FIG. 6A (FIG. 6B), a schematic cross-sectional view that is perpendicular to the longitudinal direction that passes through the point B (FIG. 6C), and a schematic cross-sectional view that is perpendicular to the longitudinal direction that passes through the point C (FIG. 6D). A microwave treatment apparatus 1b of this embodiment causes the microwave irradiating unit 22 to perform irradiation with microwaves with different frequencies, thereby performing the first microwave irradiation and the second microwave irradiation.

The microwave treatment apparatus 1b includes a vessel 10d, a microwave irradiating unit 22, a heat generating member 30, one or at least two sensors 40, a control unit 52, and conveying units 60.

The vessel 10d is the same as the vessel 10 shown in FIG. 1 in the foregoing embodiment, except that irradiating portions included in the microwave irradiating unit 22 are attached. The vessel 10d may be a vessel as described in the foregoing embodiment, and examples thereof include a vessel including multiple cavities.

Hereinafter, a case will be described in which the heat generating member 30 in the shape of one tube is provided along the movement path 2a of the treatment target 2 in the vessel 10d. Note that there may be multiple heat generating members 30. The heat generating member 30 may be the heat generating member 30 as described in the foregoing embodiment.

The microwave irradiating unit 22 can perform irradiation with microwaves with different frequencies, and perform the first microwave irradiation and the second microwave irradiation as described above by performing irradiation with microwaves with different frequencies. For example, the microwave irradiating unit 22 performs first microwave irradiation by which irradiation with microwaves is performed with a frequency at which heat generation at the heat generating member 30 is greater than heat generation at the treatment target 2, and second microwave irradiation by which irradiation with microwaves is performed with a frequency at which heat generation at the treatment target 2 is greater than heat generation at the heat generating member 30. For example, the microwave irradiating unit 22 performs first microwave irradiation by which irradiation with microwaves is performed with a frequency at which microwaves absorbed by the heat generating member 30 are greater than microwaves transmitted through the heat generating member 30 and second microwave irradiation by which irradiation with microwaves is performed with a frequency at which microwaves absorbed by the heat generating member 30 are less than microwaves transmitted through the heat generating member 30. The frequency of microwaves that are used for irradiation in the first microwave irradiation by the microwave irradiating unit 22 is hereinafter referred to as a first frequency. The frequency of microwaves that are used for irradiation in the second microwave irradiation by the microwave irradiating unit 22 is hereinafter referred to as a second frequency.

For example, microwaves that are transmitted through the heat generating member 30 depend on the frequency of microwaves that are used for irradiation. For example, if a heat generating member 30 with a complex permittivity of ε′=100 and ε″=10 is used, the half-power depth at which the electric power of microwaves that have entered the heat generating member 30 is halved is 36.3 mm if the frequency is 915 MHz, and 13.6 mm if the frequency is 2.45 GHz. Thus, in the case in which the thickness of the heat generating member 30 is set to a proper thickness, for example, if microwaves at 2.45 GHz are used for irradiation, more than half of the microwaves, preferably a large portion thereof is absorbed by the heat generating member 30, and thus the microwaves do not reach the treatment target 2 that is a precursor fiber of a carbon fiber or the like. Meanwhile, if microwaves at 915 MHz are used for irradiation, more than half of the microwaves that are used for irradiation, preferably a large portion thereof is transmitted through the heat generating member 30, and thus the precursor fiber of a carbon fiber can be irradiated with the microwaves. The thickness of the heat generating member 30 in this case may be considered as the thickness of the heating medium 301 of the heat generating member 30. Thus, in the first microwave irradiation, if the heat generating member 30 is irradiated with microwaves with a frequency corresponding to a half-power depth at which microwaves absorbed by the heat generating member 30 are greater than microwaves transmitted through the heat generating member 30, the heat generating member 30 can be heated in the first microwave irradiation, and, in the second microwave irradiation, if the heat generating member 30 is irradiated with microwaves with a frequency corresponding to a half-power depth at which microwaves absorbed by the heat generating member 30 are less than microwaves transmitted through the heat generating member, the treatment target 2 is irradiated with the microwaves transmitted through the heat generating member 30, and thus the treatment target 2 inside the heat generating member can be heated in the second microwave irradiation.

For example, if the heat generating member 30 (e.g., the heating medium 301 of the heat generating member 30) is made of aluminum with an electrical resistivity of 2.8×10⁻⁸ Ωm, the skin depth at which the electric field strength of microwaves that have entered the heat generating member 30 is 1/e is 2.2 μm if the frequency is 915 MHz, and 1.3 μm if the frequency is 2.45 GHz. Thus, if the thickness of the heat generating member 30 (e.g., the thickness of the heating medium 301 of the heat generating member 30) is controlled to, for example, in the unit of approximately hundred nanometers, in the first microwave irradiation with a first frequency of 2.45 GHz, a large portion of microwaves is absorbed by the heat generating member 30, and thus the microwaves can be prevented from reaching the treatment target 2 that is a precursor of a carbon fiber or the like, whereas, in the second microwave irradiation with a second frequency of 915 MHz, a large portion of microwaves is not absorbed by the heat generating member 30, the treatment target 2 is irradiated with the microwaves, and thus the treatment target 2 can be heated. In the above-described complex permittivity, the imaginary part ε″ may be also referred to as a relative dielectric loss.

For example, when the treatment target 2 moves, the microwave irradiating unit 22 may perform the first microwave irradiation and the second microwave irradiation to different positions on the movement path 2a of the treatment target 2. The microwave irradiating unit 22 may simultaneously perform the first microwave irradiation and the second microwave irradiation to the same position on the movement path 2a of the treatment target 2. The microwave irradiating unit 22 may perform, in a switchable manner, the first microwave irradiation and the second microwave irradiation to the same position on the movement path 2a of the treatment target 2. The microwave irradiating unit 22 may change the power of microwaves that are used for irradiation at each frequency.

For example, it is also possible that the microwave irradiating unit 22 includes one or more irradiating portions (not shown) that can change the frequency of microwaves that are used for irradiation, and perform, in a switchable manner, the first microwave irradiation and the second microwave irradiation by changing the frequency of microwaves that are used for irradiation. It is also possible that the microwave irradiating unit 22 includes one or more irradiating portions (hereinafter, referred to as first frequency irradiating portions 204) that perform irradiation with microwaves with the first frequency for performing the first microwave irradiation and one or more irradiating portions (hereinafter, referred to as second frequency irradiating portions 205) that perform irradiation with microwaves with the second frequency that is different from the first frequency, for performing the second microwave irradiation, and perform irradiation with microwaves with different frequencies used for irradiation by these irradiating portions, thereby performing the first microwave irradiation and the second microwave irradiation. Hereinafter, in this embodiment, a case will be described as an example in which the first microwave irradiation is performed using one or more first frequency irradiating portions 204 and the second microwave irradiation is performed using one or more second frequency irradiating portions 205.

For example, the first frequency irradiating portions 204 and the second frequency irradiating portions 205 are attached to the opening portions 102 that are formed at different positions through the wall face of the vessel 10d, and irradiate the internal portion of the vessel 10d with microwaves. The first frequency irradiating portions 204 and the second frequency irradiating portions 205 may be provided such that different positions on the movement path of the treatment target 2 are irradiated with microwaves or may be provided such that the same position is irradiated with microwaves.

In FIG. 6, an example is described in which one of the first frequency irradiating portions 204 is attached to the vessel 10d such that an area including the point A is irradiated with microwaves with the first frequency, one of the second frequency irradiating portions 205 is attached to the vessel 10d such that an area including the point B is irradiated with microwaves with the second frequency, and one of the first frequency irradiating portions 204 and one of the second frequency irradiating portions 205 are attached such that an area including the point C is irradiated with microwaves with the first frequency and the second frequency. For example, an example is shown in which the first frequency irradiating portions 204 are provided above the points A and C, and the second frequency irradiating portions 205 are provided above the point B and below the point C. There is no limitation on the positions at which the first frequency irradiating portions 204 and the second frequency irradiating portions 205 are provided, the number of irradiating portions provided, and the like.

As described in the foregoing embodiment, each of the first frequency irradiating portions 204 and the second frequency irradiating portions 205 includes, for example, a microwave oscillator 2001 and a transmitting portion 2002. Note that the frequencies of microwaves that are produced by the microwave oscillators 2001 are different between the first frequency irradiating portions 204 and the second frequency irradiating portions 205. The microwave oscillators 2001 that are included in the irradiating portions 203 are preferably semiconductor oscillators. The first frequency irradiating portions 204 and the second frequency irradiating portions 205 may have structures other than those described above.

The one or at least two sensors 40 are, for example, the same as the sensors in the foregoing embodiment. In this example, a case is described as an example in which three sensors 40 are provided at positions respectively near the point A, the point B, and the point C in the vessel 10d, for example, near positions above the point A, the point B, and the point C in the vessel 10d.

The conveying units 60 are the same as those in the foregoing embodiment, and thus a detailed description thereof has been omitted.

The control unit 52 controls the power of microwaves that are used for irradiation by the first frequency irradiating portions 204 and the second frequency irradiating portions 205 included in the microwave irradiating unit 22. For example, the control unit 52 performs feedback control on the power of the first frequency irradiating portions 204 and the second frequency irradiating portions 205 that irradiate the point A, the point B, and the point C with microwaves, according to the information of the temperatures of the treatment target 2 acquired by the three sensors 40. Note that the control does not have to be feedback control. If the microwave irradiating unit 22 includes multiple irradiating portions (not shown) that can control the phases of microwaves that are used for irradiation, the control unit 52 may control the frequency of microwaves that are used for irradiation by the irradiating portions respectively included in the microwave irradiating unit 22.

Next, an operation the microwave treatment apparatus 1b of this embodiment will be described by way of a specific example. In this example, a case will be described as an example in which flame-resistance treatment on a PAN-based precursor fiber that is the treatment target 2 is performed using the microwave treatment apparatus 1b. Hereinafter, for the sake of convenience of description, a description will be given using the microwave treatment apparatus 1b shown in FIG. 6. It is assumed that the microwaves that are used for irradiation by the first frequency irradiating portions 204 are microwaves with the first frequency at which microwaves absorbed by the heat generating member 30 are greater than microwaves transmitted through the heat generating member 30, and the microwaves that are used for irradiation by the second frequency irradiating portions 205 are microwaves with the second frequency at which microwaves absorbed by the heat generating member 30 are less than microwaves transmitted through the heat generating member 30. Also, it is assumed that the heat generating member 30 in this case has a thickness that allows the heat generating member to absorb more than half of the microwaves with the first frequency that are used for irradiation, preferably a large portion thereof, and to transmit more than half of the microwaves with the second frequency that are used for irradiation, preferably a large portion thereof, without absorbing the microwaves.

For example, in a state in which the treatment target 2 is conveyed by the conveying units 60, microwaves 16 at the first frequency are always used for irradiation by the first frequency irradiating portions 204, and microwaves 17 at the second frequency are always used for irradiation by the second frequency irradiating portions 205. In this example, it is assumed that the power of the microwaves 16 that are used for irradiation by the first frequency irradiating portions 204 and the power of the microwaves 17 that are used for irradiation by the second frequency irradiating portions 205 are subjected to feedback control according to the information of temperature acquired by the sensors 40 provided respectively in the vicinity thereof.

At the point A, the microwaves 16 at the first frequency are used for irradiation by the first frequency irradiating portions 204, and thus the first microwave irradiation is performed. Thus, microwaves are likely to be absorbed by the heat generating member 30, and the treatment target 2 is not likely to be irradiated with the microwaves 16, as a result of which, as shown in FIG. 6B, the heat generation at the heat generating member 30 is greater than the heat generation at the treatment target 2. Accordingly, the treatment target 2 is heated from the outside by radiant heat from the heat generating member 30. Although the amount of heat is smaller than that of the heat generating member 30, the treatment target 2 is directly heated as well by part of the microwaves 16 that are used for irradiation.

At the point B, the microwaves 17 at the second frequency are used for irradiation by the second frequency irradiating portions 205, and thus the second microwave irradiation is performed. Thus, microwaves are unlikely to be absorbed by the heat generating member 30, and the treatment target 2 is irradiated with the microwaves 17 transmitted through the heat generating member 30, as a result of which, as shown in FIG. 6C, the heat generation at the treatment target 2 is greater than the heat generation at the heat generating member 30. Accordingly, the treatment target 2 is directly heated by the microwaves 17 that are used for irradiation. The heat generating member 30 is heated as well by part of the microwaves 17 that are used for irradiation, and thus the treatment target 2 is heated from the outside by radiant heat from the heat generating member 30.

At the point C, the microwaves 16 at the first frequency are used for irradiation by the first frequency irradiating portions 204 to perform the first microwave irradiation and the microwaves 17 at the second frequency are used for irradiation by the second frequency irradiating portions 205, and thus the second microwave irradiation is performed. Due to the microwaves 16 at the first frequency, the heat generation at the heat generating member 30 is greater than the heat generation at the treatment target 2. Meanwhile, due to the microwaves 17 at the second frequency, the heat generation at the treatment target 2 by the microwaves 17 at the second frequency is greater than the heat generation at the heat generating member 30. Accordingly, as shown in FIG. 6D, the treatment target 2 is heated from the outside by radiant heat from the heat generating member 30 by being irradiated with the microwaves 16 at the first frequency, and is directly heated by being irradiated with the microwaves 17 at the second frequency.

The power of the microwaves 16 and 17 with which the points A to C are irradiated is subjected to feedback control, for example, by the control unit 52 controlling the power of the first frequency irradiating portions 204 and the second frequency irradiating portions 205 that irradiate the respective points with microwaves, according to the information of the temperatures of the treatment target 2 acquired by the sensors 40 provided in portions respectively near the points.

It is possible to control the ratio between the amount of heat generated at the heat generating member 30 and the amount of heat generated at the treatment target 2 at the point C, by individually changing the power of the first frequency irradiating portions 204 and the second frequency irradiating portions 205 that perform irradiation the microwaves 16 and 17 with different frequencies to the point C. For example, it is possible to make the amount of heat generated at the heat generating member 30 higher than the amount of heat generated at the treatment target 2, by increasing only the power of the microwaves 16 at the first frequency that are used for irradiation by the first frequency irradiating portions 204, and it is possible to make the amount of heat generated at the treatment target 2 higher than the amount of heat generated at the heat generating member 30, by increasing only the power of the microwaves 17 at the second frequency that are used for irradiation by the second frequency irradiating portions 205.

For example, as described in the foregoing embodiment, at or near the position corresponding to the heat generation peak at the treatment target 2 on the movement path 2a, if the microwave irradiation at the first frequency is performed in which the heat generation at the heat generating member 30 is greater than that at the treatment target 2 in a way similar to that at the point A described above, it is possible to properly treat the treatment target 2 while avoiding abrupt heating when the treatment target 2 reaches its heat generation peak. Also, at other positions on the movement path 2a, for example, if microwaves with the first frequency, microwaves with the second frequency, or both microwaves with the first frequency and microwaves with the second frequency are used for irradiation as appropriate, it is possible to perform the first microwave irradiation and the second microwave irradiation in a proper combination to the treatment target 2 that moves, and to perform desired heating of the treatment target 2.

The arrangement and the like of the first frequency irradiating portions 204 and the second frequency irradiating portions 205 are merely an example, and there is no limitation on the arrangement, the number, and the like of the first frequency irradiating portions 204 and the second frequency irradiating portions 205. It is sufficient that the microwave treatment apparatus 1b includes at least one or more first frequency irradiating portions 204 and at least one or more second frequency irradiating portions 205. For example, it is also possible that multiple first frequency irradiating portions 204 and multiple second frequency irradiating portions 205 are attached to the vessel 10.

Furthermore, in the above-described specific example, it is also possible that the first frequency irradiating portions 204 and the second frequency irradiating portions 205 are provided as irradiating portions that irradiate multiple points with microwaves, and one or more of the multiple points are irradiated with microwaves with different frequencies in a way similar to that to the point C. In this case, it is also possible to irradiate one point with microwaves by only one of the first frequency irradiating portions 204 and the second frequency irradiating portions 205, thereby performing irradiation with microwaves only with either one of the frequencies, or to switch the irradiating portion that irradiates one point with microwaves between the first frequency irradiating portions 204 and the second frequency irradiating portions 205, thereby changing frequency of microwaves with which the one point is irradiated.

Furthermore, in the above-described specific example, it is also possible that, instead of providing the first frequency irradiating portions 204 and the second frequency irradiating portions 205, multiple irradiating portions (not shown) that can change the frequency are provided, for example, along the movement path 2a, and microwaves with a frequency suitable for each position are used for irradiation therefrom. For example, it is also possible that multiple irradiating portions that can change the frequency are provided above the points A to C as shown in FIG. 6, microwaves with the first frequency are used for irradiation by the irradiating portions above the point A and the point C, and microwaves with the second frequency are used for irradiation by the irradiating portion above the point B. In this manner, it is also possible that one irradiating portion that performs irradiation with microwaves with the first frequency and one irradiating portion that performs irradiation with microwaves with the second frequency are realized by one irradiating portion.

Furthermore, in this case, the frequency of microwaves that are used for irradiation by each irradiating portion may be changed as appropriate. For example, according to the material, the thickness, the movement speed, and the like of the treatment target 2, the frequency of microwaves that are used for irradiation by the irradiating portion above the point B may be changed from the second frequency to the first frequency, and the frequency of microwaves that are used for irradiation by the irradiating portion above the point C may be changed from the first frequency to the second frequency. The frequency of microwaves that are used for irradiation by each irradiating portion may be changed according to the information of temperature and the like acquired by the sensors 40.

Furthermore, it is also possible that multiple irradiating portions (not shown) that irradiate one or more points with microwaves are provided, each irradiating portion is an irradiating portion that can change the frequency of microwaves that are used for irradiation therefrom, the frequencies of microwaves of the multiple irradiating portions that irradiate each point with microwaves are different frequencies, and thus each point can be irradiated with microwaves with different frequencies. In this case, it is also possible that microwaves of the multiple irradiating portions that irradiate one point with microwaves are microwaves with the same frequency, or only one irradiating portion performs irradiation with microwaves, and thus a point that does not have to be irradiated with microwaves with different frequencies is irradiated with microwaves with only one frequency.

As described above, in this embodiment, it is possible to properly treat a treatment target using microwaves, by irradiating the internal portion of the vessel with microwaves with different frequencies, thereby performing the first microwave irradiation and the second microwave irradiation. For example, it is possible to perform proper heating, by controlling the combination and the ratio between the heating of a treatment target from the outside by a heat generating member caused to generate heat by microwaves, and the direct heating of a treatment target by causing the treatment target to generate heat with microwaves.

In Embodiment 3 above, it is also possible that the microwave irradiating unit 22 performs first microwave irradiation by which irradiation with microwaves is performed with a frequency at which a loss of microwaves to the heat generating member 30 is larger than a loss in the treatment target 2, and second microwave irradiation by which irradiation with microwaves is performed with a frequency at which a loss in the heat generating member 30 is less than a loss in the treatment target 2, instead of the above-described first microwave irradiation and second microwave irradiation. The loss of microwaves in this case may be considered as heat generation at the heat generating member 30 or the treatment target 2 with microwaves. The loss of microwaves can be expressed, for example, as a relative dielectric loss or the like. The relative dielectric loss is an imaginary part ε″ of the complex permittivity. Typically, heat generation through microwave irradiation increases in accordance with an increase in a relative dielectric loss, and heat generation through microwave irradiation decreases in accordance with a decrease in relative dielectric loss.

The frequency of microwaves that are used for irradiation in the first microwave irradiation in this manner may be considered as the above-described first frequency. The frequency of microwaves that are used for irradiation in the second microwave irradiation in this manner may be considered as the above-described second frequency. The relative dielectric loss in the heat generating member 30 in this case may be considered as the relative dielectric loss in the heating medium 301 of the heat generating member 30.

In the description above, it is also possible that the vessel 10d includes multiple cavities, for example, one or at least two of either the first frequency irradiating portions 204 or the second frequency irradiating portions 205 are attached to each cavity, and thus the internal portion of each cavity is irradiated with microwaves with different frequencies. With this configuration, the treatment target 2 in each cavity can be irradiated with microwaves with different frequencies, and thus it is easy to control the power of microwaves with different frequencies that are used for irradiation, and the like.

Furthermore, in the foregoing embodiment, the case was described as an example in which the treatment target moves inside the vessel, but it is also possible that the treatment target 2 does not move inside the vessel 10d, and the frequency of microwaves with which the internal portion of the vessel 10d is irradiated is changed over time, and thus the first microwave irradiation for heating the heat generating member 30 and the second microwave irradiation for heating the treatment target 2 can be performed in a switchable manner in a time unit, and the heating of the treatment target 2 from the heat generating member 30 and the direct heating of the treatment target 2 with microwaves can be performed in a switchable manner in a time unit.

In Embodiment 3 above, the case was described in which the microwave irradiating unit 22 performs irradiation with microwaves with two different frequencies, but it is also possible that the microwave irradiating unit 22 can perform irradiation with microwaves with three or more different frequencies.

For example, it is also possible that the microwave irradiating unit 22 includes one or more of each of three or more types of irradiating portions that perform irradiation with microwaves with different frequencies. It is also possible that the microwave irradiating unit 22 includes three or more irradiating portions that can change the frequency of microwaves that are used for irradiation, and the frequencies of microwaves that are used for irradiation by the irradiating portions such that three or more of them perform irradiation with microwaves with different frequencies. In the foregoing embodiment, it is also possible that portions of the multiple irradiating portions that can be shared are shared.

Furthermore, in Embodiment 2 above, it is also possible that two or more irradiating portions 203 that perform the first microwave irradiation perform irradiation with microwaves with the first frequency, and two or more irradiating portions 203 that perform the second microwave irradiation perform irradiation with microwaves with the second frequency as described in Embodiment 3 above.

### Modified Example 1

In the microwave treatment apparatus 1b of Embodiment 3, it is also possible that one or at least two heat generating members 30 are provided inside the vessel 10d along part of the movement path 2a of the treatment target 2 as in Embodiment 1 described above, and the microwave irradiating unit 22 performs the first microwave irradiation by which one or more portions in which the heat generating members 30 are provided on the movement path 2a are irradiated with microwaves, thereby heating the heat generating members 30, and the second microwave irradiation by which one or more portions in which the heat generating members 30 are not provided on the movement path 2a are irradiated with microwaves with a frequency that is different from that in the first microwave irradiation, thereby heating the treatment target. In other words, it is also possible that the microwave irradiating unit 22 irradiates one or more portions in which the heat generating members 30 are provided on the movement path 2a and one or more portions in which the heat generating members 30 are not provided on the movement path 2a, with microwaves with different frequencies.

In this case, it is preferable that the frequency of microwaves for use in the first microwave irradiation is set to a frequency at which the relative dielectric loss in the heat generating members 30 is larger than the relative dielectric loss in the treatment target 2. Also, it is preferable that the frequency of microwaves for use in the second microwave irradiation is set to a frequency at which the relative dielectric loss in the treatment target 2 is larger than the relative dielectric loss in the heat generating members 30. Note that the frequency of microwaves for use in the second microwave irradiation may be a frequency at which the relative dielectric loss in the treatment target 2 is not larger than the relative dielectric loss in the heat generating members 30.

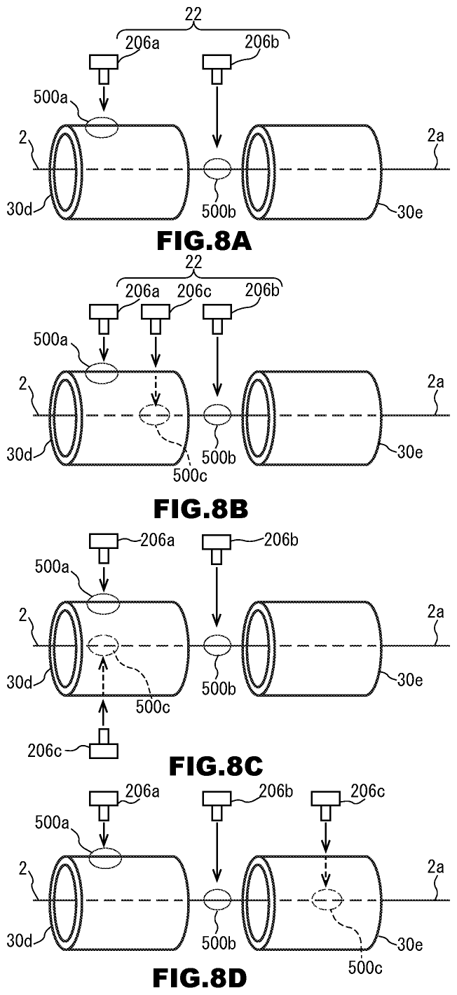

FIG. 8A is a view illustrating an example of a modified example of the microwave treatment apparatus 1b. This microwave treatment apparatus 1b is the microwave treatment apparatus 1b of Embodiment 3, wherein heat generating members 30d and 30e that are two heat generating members 30 as described in the modified example of Embodiment 2 are provided inside the vessel 10d at a predetermined interval along part of the movement path 2a of the treatment target 2, and the microwave irradiating unit 22 includes two irradiating portions 206a and 206b that perform irradiation with microwaves with different frequencies from different positions, instead of the irradiating portion 204 and the irradiating portion 205. In FIG. 8A, the vessel, the sensors, and the control unit, and the like are not shown. The solid arrows in the drawing schematically indicate microwaves that are used for irradiation by the irradiating portion 206a and the irradiating portion 206b.

As shown in FIG. 8A, the irradiating portion 206a is attached at a position (e.g., the position on an unshown vessel that faces the side face of the heat generating member 30d) from which the heat generating member 30d can be irradiated with microwaves, and performs the first microwave irradiation by emitting microwaves with a frequency at which the relative dielectric loss in the heat generating member 30d is larger than the relative dielectric loss in the treatment target 2. As shown in FIG. 8A, the irradiating portion 206b is attached at a position (e.g., the position on an unshown vessel that faces the area in which no heat generating members 30 is provided between the heat generating members 30d and 30e) from which the treatment target 2 that is located at the portion in which no heat generating member 30 is provided between the heat generating members 30d and 30e can be irradiated with microwaves, and performs the second microwave irradiation by emitting microwaves with a frequency that is different from that in the first microwave irradiation. The irradiating portions 206a and 206b may be irradiating portions as described above that are similar to the irradiating portion 204 and the irradiating portion 205 and the like that can perform irradiation with microwaves with the above-described frequencies.

In the microwave treatment apparatus 1b shown in FIG. 8A, when the irradiating portion 206a performs the first microwave irradiation, at a position 500a at which the microwaves used for irradiation are incident on the heat generating member 30d, the relative dielectric loss in the heat generating member 30d is larger than the relative dielectric loss in the treatment target 2 due to the frequency for use in the first microwave irradiation, the heating efficiency is higher than that at the treatment target 2 that is located inside the heat generating member 30d under the position 500a, and thus it is possible to efficiently heat the heat generating member 30d, and to efficiently heat the treatment target 2 that is located inside, from the outside by the heated heat generating member 30d. At the position inside the heat generating member 30d under the position 500a, it is possible to suppress direct heating of the treatment target 2. When the irradiating portion 206b performs the second microwave irradiation, at a position 500b at which the microwaves used for irradiation are incident on the treatment target 2 that is located at the portion in which no heat generating member is provided, it is possible to perform only direct heating of the treatment target 2 because no heat generating member 30 is provided. If the frequency of microwaves for use in the second microwave irradiation that are used for irradiation by the irradiating portion 206b is set to a frequency at which the relative dielectric loss in the treatment target 2 is large, it is possible to improve the heating efficiency of direct heating of the treatment target 2. The position 500a and the position 500b shown in FIG. 8A are positions for description, and do not strictly indicate the positions and the like that are actually irradiated with microwaves. The same applies to FIGS. 8B to 8D below. The same applies to a later-described position 500c.

In this manner, in this modified example, it is possible to perform desired heating of the treatment target 2 at each of the positions at which the heat generating members 30 are provided and the positions at which the heat generating members 30 are not provided, by irradiating the heat generating members 30, and the treatment target 2 that is located in the areas in which the heat generating members 30 are not provided, with microwaves different frequencies. In particular, it is possible to suppress heating of the treatment target 2 in the portions in which the heat generating members 30 are provided, by irradiating the heat generating members 30 with microwaves with a frequency at which the relative dielectric loss in the heat generating member 30d is larger than the relative dielectric loss in the treatment target 2.

### Modified Example 2

In the microwave treatment apparatus 1b described in Modified Example 1 above, it is also possible that the microwave irradiating unit 22 further performs, in addition to the above-described first microwave irradiation and second microwave irradiation, third microwave irradiation by which the portions in which the heat generating members 30 are provided are irradiated with microwaves with a frequency at which the relative dielectric loss in the partially provided heat generating members 30 is smaller than the relative dielectric loss in the treatment target 2, thereby heating the treatment target in the portions in which the heat generating members 30 are provided.

FIGS. 8B to 8D are schematic views showing the heat generating members 30d and 30e and the vicinity thereof, illustrating a modified example of the microwave treatment apparatus 1b that further performs the above-described third microwave irradiation, where the reference numerals that are the same as those in FIG. 8A denote the same or corresponding constituent elements. In the drawings, a irradiating portion 206c performs the third microwave irradiation, by irradiating the portions in which the heat generating members 30 are provided, with microwaves with a frequency at which the relative dielectric loss in the heat generating members 30 is smaller than the relative dielectric loss in the treatment target 2. The irradiating portion 206c may be an irradiating portion as described above that is similar to the irradiating portion 204 and the irradiating portion 205 and the like that can perform irradiation with microwaves with the above-described frequencies. The irradiating portion 206c is attached to a vessel (not shown). The solid arrows in the drawings schematically indicate microwaves that are used for irradiation by the irradiating portion 206a and the irradiating portion 206b, and the dashed arrow schematically indicates microwaves transmitted through the heat generating member 30. In the drawings, it is assumed that a later-described position 500c indicates a position inside the heat generating member 30d.

It is assumed that, as shown in FIG. 8B, the irradiating portion 206c is attached at a position on a vessel (not shown) that faces the side face of the heat generating member 30d such that a position on the heat generating member 30d is irradiated with microwaves, the position being different from the position 500a at which microwaves emitted from the irradiating portion 206a are incident through the first microwave irradiation. In this example, a case will be described as an example in which the irradiating portions 206 are attached such that the position at which microwaves used for irradiation by the irradiating portion 206c are incident on the heat generating member 30d is closer to the heat generating member 30e than the position 500a is, but it is also possible that the irradiating portions 206 are attached such that the position at which microwaves used for irradiation by the irradiating portion 206c are incident on the heat generating member 30d is farther from the heat generating member 30e than the position 500a is.

In the microwave treatment apparatus 1b shown in FIG. 8B, when the irradiating portion 206a performs the first microwave irradiation as in the microwave treatment apparatus 1b in FIG. 8A, at the position 500a at which the microwaves used for irradiation are incident on the heat generating member 30d, it is possible to efficiently heat the heat generating member 30d, and to suppress direct heating of the treatment target 2 in a portion under the position 500a. When the irradiating portion 206b performs the second microwave irradiation, at the position 500b at which the microwaves used for irradiation are incident on the treatment target 2 that is located in the area in which no heat generating member is provided, it is possible to perform only direct heating of the treatment target 2. Furthermore, when the irradiating portion 206c performs the third microwave irradiation, the relative dielectric loss in the treatment target 2 is larger than the relative dielectric loss in the heat generating member 30d due to the frequency for use in the third microwave irradiation, and thus, at a position 500c at which microwaves emitted from the irradiating portion 206c are incident on the treatment target 2 that is located inside the heat generating member 30d, the heating efficiency of the treatment target 2 is high, as a result of which it is possible to efficiently perform direct heating of the treatment target 2 that is located inside. Also, in a portion in which microwaves emitted from the irradiating portion 206c are incident on the heat generating member 30d, the heating efficiency is low, and thus it is possible to suppress heating of the heat generating member 30d from the outside through microwave irradiation by the irradiating portion 206c, and to suppress heating of the treatment target 2 from the outside by the heated heat generating member 30d.

In this manner, in this modified example, it is possible to properly heat the treatment target 2, by performing the first microwave irradiation, the second microwave irradiation, and the third microwave irradiation.

The microwave treatment apparatus 1b described with reference to FIG. 8B may be configured such that irradiation with microwaves is performed such that the position 500a irradiated with microwaves by the first microwave irradiation and the position 500c irradiated with microwaves by the third microwave irradiation are the same position in the direction that is along the movement path 2a of the treatment target 2. For example, as shown in FIG. 8C, the microwave treatment apparatus 1b described with reference to FIG. 8B may be configured such that the position 500a and the position 500c are the same position in the direction that is along the movement path 2a of the treatment target 2, by attaching the irradiating portion 206a and the irradiating portion 206c to the vessel (not shown) such that their positions from which microwaves are emitted face each other with the heat generating member 30d interposed therebetween, and such that the position irradiated with microwaves by the first microwave irradiation and the position irradiated with microwaves by the third microwave irradiation are the same position in the direction that is along the movement path 2a. Note that the arrangement of the irradiating portion 206a and the irradiating portion 206c is not limited to that described above, as long as the first microwave irradiation and the third microwave irradiation can be performed such that the positions to which irradiation with microwaves is performed are the same position in the direction that is along the movement path 2a of the treatment target 2. For example, it is also possible that the irradiating portion 206a and the irradiating portion 206c are attached to the vessel such that their positions from which microwaves are emitted are the same position in the direction that is along the movement path 2a of the treatment target 2, and do not face each other with the heat generating member 30d interposed therebetween. In the description above, it is also possible that irradiation with microwaves is performed such that the position 500a irradiated with microwaves by the first microwave irradiation and the position 500c irradiated with microwaves by the third microwave irradiation are the same position also in the width direction of the vessel 10d. The position 500a irradiated with microwaves by the first microwave irradiation may be considered as the position at which one heat generating member 30 is heated through the first microwave irradiation, and the position 500c irradiated with microwaves by the third microwave irradiation may be considered as the position at which the treatment target 2 that is located in the portion in which one heat generating member 30 is provided is heated through the third microwave irradiation. The same applies to the description below.

Furthermore, the microwave treatment apparatus 1b described with reference to FIG. 8B may be configured such that the position 500a irradiated with microwaves by the first microwave irradiation and the position 500c irradiated with microwaves by the third microwave irradiation are provided in portions in which different heat generating members 30 are provided. For example, it is also possible that, as shown in FIG. 8D, the position 500a irradiated with microwaves by the first microwave irradiation is provided in the portion in which the heat generating member 30d is provided, and the position 500c irradiated with microwaves by the third microwave irradiation is provided in the portion in which the heat generating member 30e is provided. In this case, for example, it is sufficient to arrange the irradiating portion 206a at the position that faces the side face of the heat generating member 30d such that the position 500a irradiated with microwaves by the first microwave irradiation is provided in the portion in which the heat generating member 30d is provided, and to arrange the irradiating portion 206c at the position that faces the side face of the heat generating member 30e such that the position 500c irradiated with microwaves by the third microwave irradiation is provided in the portion in which the heat generating member 30e is provided. Note that the arrangement of the irradiating portion 206a and the irradiating portion 206c is not limited to that described above, as long as irradiation with microwaves can be performed such that the position 500a irradiated with microwaves by the first microwave irradiation and the position 500c irradiated with microwaves by the third microwave irradiation are provided in portions in which different heat generating members 30 are provided.

In the description above, the case was described as an example in which the number of heat generating members 30 is two, but it is sufficient that the number of heat generating members 30 is one or more, if the third microwave irradiation is not performed as shown in FIG. 8A, if the position irradiated with microwaves by the first microwave irradiation and the position irradiated with microwaves by the third microwave irradiation are provided in a portion in which the same heat generating member 30 is provided as shown in FIGS. 8B and 8C, or if different heat generating members do not have to be irradiated with microwaves. The lengths, materials, and the like of at least some of the two or more heat generating members 30 may be the same or different from each other.

Furthermore, it is sufficient that the number of heat generating members 30 is two or more, if the position irradiated with microwaves by the first microwave irradiation and the position irradiated with microwaves by the third microwave irradiation are provided in portions in which different heat generating members 30 are provided as shown in FIG. 8C.

Furthermore, the heat generating member 30 irradiated with microwaves by the first microwave irradiation and the area in which no heat generating member is provided and irradiated with microwaves by the second microwave irradiation may be adjacent to each other as shown in FIG. 8B, or may not be adjacent to each other.

Furthermore, if the position irradiated with microwaves by the first microwave irradiation and the position irradiated with microwaves by the third microwave irradiation are provided in portions in which different heat generating members 30 are provided, the first microwave irradiation position and the third microwave irradiation position may be heat generating members 30 that are adjacent to each other between which only one area in which no heat generating member 30 is provided, or may be heat generating members 30 that are provided such that two or more areas in which no heat generating member 30 is provided are interposed therebetween.

Furthermore, there is no limitation on the number of irradiating portion 206a included in the microwave treatment apparatus 1b, as long as it is one or more. The same applies to the irradiating portion 206b and the irradiating portion 206c.

Furthermore, it is also possible that the microwave irradiating unit 21 performs irradiation with microwaves such that the positions irradiated with microwaves by the first microwave irradiation are set to different multiple positions in the microwave treatment apparatus 1b. For example, the microwave irradiating unit 21 may include multiple irradiating portions 206a that perform the first microwave irradiation to different multiple positions. The same applies to the second and third microwave irradiation positions.

Furthermore, in the foregoing embodiments, the case was described as an example in which the microwave treatment apparatus performs flame-resistance treatment on a treatment target that is a PAN-based precursor fiber or the like, but the microwave treatment apparatus can be used in treatment on treatment targets other than the precursor fibers and in treatment other than the flame-resistance treatment, and, also in these cases, effects that are similar to those in the foregoing embodiment are achieved. For example, there is no limitation on the material and the like of the treatment target. For example, the treatment target may be a cotton string, a wool string, a cashmere string, a polymer string, a metal string, or the like. The polymer string is, for example, a nylon string, a fluorocarbon string, a polythene string, or the like. For example, the above-described microwave treatment apparatus may be used to dry a cotton string, a wool string, a cashmere string, or the like. For example, the microwave treatment apparatus in the foregoing embodiments may be used in treatment such as heating, firing, sintering, or the like of a polymer string, a metal string, or the like. The microwave treatment apparatus in the foregoing embodiments may be used in carbonization treatment on a precursor fiber that has undergone flame-resistance treatment, that is, treatment to produce a carbon fiber using a precursor fiber that has undergone flame-resistance treatment. In the microwave treatment apparatus in the foregoing embodiments, after flame-resistance treatment as described above is performed on a precursor fiber, carbonization treatment may be performed in the same vessel to produce a carbon fiber. The treatment target 2 is not limited to those in the form of a fiber, and examples of the form include other forms such as a rod form, a chain form, a sheet form, a film form, and a tube form. The treatment target 2 does not absolutely have to continuously extend or to be continuously linked in a predetermined direction, as long as the treatment target 2 can be located inside the heat generating member or the like or can move inside the heat generating member, and, for example, it may be solid materials that are not continuous and that are placed on a belt (not shown) made of a material with high microwave transmission and configured to move inside the vessel from the inlet side to the outlet side, or may be a fluid such as a liquid or a powder, a gel, or the like that is placed and moves inside a tube or a pipe made of a material such as glass with high microwave transmission and configured to extend inside the vessel from the inlet side to the outlet side. The number of sets of microwaves that are used for irradiation by a microwave irradiating unit in the microwave apparatus, the microwave irradiation position, the power of microwaves, the frequency of microwaves, and the like are set as appropriate according to the treatment target, the treatment that is performed on a treatment target, and the like.

When producing a carbon fiber using a precursor fiber that has undergone flame-resistance treatment in the microwave treatment apparatus, for example, it is preferable that the gas supply units 70 described above supplies gas such as nitrogen necessary to produce a carbon fiber.

Furthermore, in the foregoing embodiments, the example was described in which the winding portion 65 that takes up the treatment target that has undergone treatment is arranged on the downstream side of the microwave treatment apparatus, but it is also possible that the treatment target that has undergone flame-resistance treatment is supplied to another treatment apparatus (not shown) without being taken up. For example, a precursor fiber that has undergone flame-resistance treatment with the microwave treatment apparatus may be sent as is into an apparatus (not shown) that performs carbonization treatment on the precursor fiber that has undergone flame-resistance treatment, using the conveying units 60.

The flame-resistance treatment on a precursor fiber of a carbon fiber described in the foregoing embodiments may be considered as a step of the method for producing a carbon fiber. That is to say, the method for producing a carbon fiber including the flame-resistance treatment includes a step of irradiating an internal portion of a vessel with microwaves, the vessel including, therein, a heat generating member that generates heat by absorbing microwaves, thereby heating a precursor fiber of a carbon fiber that is provided along the heat generating member, wherein, in the heating step, the first microwave irradiation by which a heat generating member is heated and the second microwave irradiation by which a precursor fiber is heated are performed.

In the method for producing a carbon fiber, it is preferable that, when a precursor fiber reaches a temperature corresponding to the heat generation peak during the second microwave irradiation, the second microwave irradiation is stopped and the first microwave irradiation is performed. When reaching a temperature corresponding to the heat generation peak is, for example, a period including a point in time when reaching a temperature corresponding to the heat generation peak, and preferably a period including a point in time when reaching a temperature corresponding to the heat generation peak, and points in time before and after that point.

The present invention is not limited to the embodiment set forth herein. Various modifications are possible within the scope of the present invention.

### INDUSTRIAL APPLICABILITY

As described above, the microwave treatment apparatus and the like according to the present invention are suitable as an apparatus and the like for performing desired treatment on a treatment target by performing irradiation with microwaves, and are particularly useful as an apparatus and the like for performing heating.

1. A microwave treatment apparatus comprising:
a vessel inside which a treatment target moves;
a microwave irradiating unit including first and second irradiating portions that irradiate an internal portion of the vessel with microwaves; and
a heat generating member that is provided inside the vessel along a movement path of the treatment target, generates heat by absorbing part of microwaves used for irradiation by the microwave irradiating unit, and transmits part of the microwaves, the heat generating member including a support member and a heating medium that is supported by the support member,
wherein each of the first and second irradiating portions heats the treatment target from an outside through heat generation of the heating medium, and directly heats the treatment target with microwaves transmitted through the heat generating member, and
wherein the first and second irradiating portions heat the treatment target at different positions on the movement path.

2. The microwave treatment apparatus according to claim 1,
wherein the heating medium is a uniform material.

3. The microwave treatment apparatus according to claim 21, further comprising a gas supply unit that supplies predetermined gas into the heat generating member.

4. (canceled)

5. The microwave treatment apparatus according to claim 1, wherein the microwave irradiating unit performs first microwave irradiation and second microwave irradiation to the heat generating member,
the first microwave irradiation being irradiation by which the first irradiating portion performs irradiation with microwaves with a frequency corresponding to a half-power depth at which microwaves absorbed by the heat generating member are greater than microwaves transmitted through the heat generating member-, and
the second microwave irradiation being irradiation by which the second irradiating portion performs irradiation with microwaves with a frequency corresponding to a half-power depth at which microwaves absorbed by the heat generating member are less than microwaves transmitted through the heat generating member.

6. The microwave treatment apparatus according to claim 1, wherein the microwave irradiating unit performs first microwave irradiation and second microwave irradiation to the heat generating member,
the first microwave irradiation being irradiation by which the first irradiating portion performs irradiation with microwaves with a frequency at which a relative dielectric loss in the heat generating member is larger than a relative dielectric loss in the treatment target, and
the second microwave irradiation being irradiation by which the second irradiating portion irradiates the heat generating member with microwaves with a frequency at which a relative dielectric loss in the heat generating member is smaller than a relative dielectric loss in the treatment target.

7. The microwave treatment apparatus according to claim 1,
wherein the heating medium includes a first area with a first thickness and a second area with a second thickness, and
the microwave irradiating unit performs first microwave irradiation to the first area using the first irradiating portion, and second microwave irradiation to the second area using the second irradiating portion.

8. A microwave treatment apparatus comprising:
a vessel inside which a treatment target moves;
a microwave irradiating unit including first and second irradiating portions that irradiate an internal portion of the vessel with microwaves; and
a heat generating member that is provided inside the vessel along a movement path of the treatment target, generates heat by absorbing part of microwaves used for irradiation by the microwave irradiating unit, and transmits part of the microwaves, the heat generating member including a support member and a heating medium that is supported by the support member,
wherein each of the first and second irradiating portions heats the treatment target from an outside through heat generation of the heating medium, and directly heats the treatment target with microwaves transmitted through the heat generating member, and
the microwave irradiating unit controls phases of microwaves that are used for irradiation by the first and second irradiating portions, thereby performing first microwave irradiation in which microwaves used for irradiation by the first and second irradiating portions are intensified by each other at the heating medium, and second microwave irradiation in which microwaves used for irradiation by the first and second irradiating portions are intensified by each other at the treatment target, at different positions on the movement path of the treatment target.

9-10. (canceled)

11. The microwave treatment apparatus according to claim 8, further comprising:
a first sensor that acquires information of temperature of the heat generating member; and
a second sensor that acquires information of temperature of the treatment target,
wherein feedback control on power of the first and second irradiating portions is performed using the information of temperature acquired by the first and second sensors.

12-14. (canceled)

15. The microwave treatment apparatus according to claim 8,
wherein the treatment target is a precursor fiber of a carbon fiber, and
the microwave treatment apparatus is for use in flame-resistance treatment on the precursor fiber.

16. (canceled)

17. A method for producing a carbon fiber, comprising a step of irradiating an internal portion of a vessel with microwaves, the vessel including a heat generating member therein, thereby heating a precursor fiber of a carbon fiber that moves along the heat generating member,
wherein, in the heating step, the heat generating member including a support member and a heating medium that is supported by the support member is irradiated with microwaves from first and second irradiating portions, so that:
the precursor fiber is heated from an outside through heat generation of the heat generating member, and the precursor fiber is directly heated with microwaves transmitted through the heat generating member; and
heating is performed at different positions on the movement path of the precursor fiber.

18-22. (canceled)

23. The microwave treatment apparatus according to claim 1, further comprising:
a first sensor that acquires information of temperature of the heat generating member; and
a second sensor that acquires information of temperature of the treatment target,
wherein feedback control on power of the first and second irradiating portions is performed using the information of temperature acquired by the first and second sensors.

24. The microwave treatment apparatus according to claim 1,
wherein the treatment target is a precursor fiber of a carbon fiber, and
the microwave treatment apparatus is for use in flame-resistance treatment on the precursor fiber.
